(19) United States
(12) Patent Application Publication
(10) Pub. No.: US 2015/0264359 A1
(43) Pub. Date: Sep. 17, 2015

(54) VIDEO CODING USING PACKET LOSS DETECTION

(71) Applicants: Rahul Vanam, San Diego, CA (US); Weimin Liu, Chatham, NJ (US); Avi Rapaport, Shoham (IL); Liangping Ma, San Diego, CA (US); Eduardo Asbun, San Diego, CA (US); Zhifeng Chen, San Diego, CA (US); Yuriy Reznik, San Diego, CA (US); Ariela Zeira, Huntington, NY (US)

(72) Inventors: Rahul Vanam, San Diego, CA (US); Weimin Liu, Chatham, NJ (US); Avi Rapaport, Shoham (IL); Liangping Ma, San Diego, CA (US); Eduardo Asbun, San Diego, CA (US); Zhifeng Chen, San Diego, CA (US); Yuriy Reznik, San Diego, CA (US); Ariela Zeira, Huntington, NY (US)

(73) Assignee: VID SCALE, INC., Wilmington, DE (US)

(21) Appl. No.: 14/379,198

(22) PCT Filed: Feb. 15, 2013
(86) PCT No.: PCT/US2013/026353

§ 371 Date: Aug. 15, 2014

Related U.S. Application Data
(60) Provisional application No. 61/603,212, filed on Feb. 24, 2012.

(51) Int. Cl. H04N 19/154; H04N 19/172; H04L 12/26; H04N 19/103; H04N 19/46; H04N 19/65

(52) U.S. Cl. CPC H04N 19/154; H04N 19/46; H04N 19/65; H04L 43/0829; H04N 19/103; H04N 19/172

(57) ABSTRACT

Using wireless packet loss data in the encoding of video data. In one embodiment, the method includes receiving wireless packet loss data at a wireless transmit receive unit (WTRU); generating video packet loss data from the wireless packet loss data, and providing the video packet loss data to a video encoder application running on the WTRU for use in encoding video data. The video encoder may perform an error propagation reduction process in response to the video packet loss data. The error propagation reduction process includes one or more of generating an instantaneous Decode Refresh frame or generating an Intra Refresh frame. Some embodiments may be characterized as using a reference picture selection method, or a reference set of pictures selection method.

### RELATED APPLICATIONS

This application is anon-provisional of U.S. Provisional Patent Application No. 61/603212 filed Feb. 24, 2012, which is incorporated herein fully by reference.

### BACKGROUND

In recent years demand for mobile wireless video has steadily increased, and its growth is predicted to increase with the new infrastructure of the LTE/LTE-Advanced network that offers significantly higher user data rates. Although present-day wireless networks have increased capacity, and smart phones are now capable of generating and displaying video, actually transporting video across these advanced wireless communication networks has become challenging.

### SUMMARY

Embodiments described herein include methods for using wireless packet loss data in the encoding of video data. In one embodiment, the method comprises receiving wireless packet loss data at a wireless transmit receive unit (WTRU); generating video packet loss data from the wireless packet loss data, and providing the video packet loss data to a video encoder application running on the WTRU for use in encoding, video data. The video encoder may perform an error propagation reduction process in response to the video packet loss data. The error propagation reduction process may include one or more of generating an Instantaneous Decode Refresh (IDR) frame or generating an Intra Refresh (I) frame. Some embodiments may be characterized as using a reference picture selection (RPS) method, or a reference set of pictures selection (RPSP) method.

In some embodiments, the wireless packet loss data is provided by a base station to the wireless transmit receive unit (WTRU). The wireless packet loss data may be generated at the Radio Link Control (RLC) protocol layer, which may be operating in acknowledged mode or unacknowledged mode. The wireless packet loss data may include, or be generated from a NACK message. The NACK message may be synchronous with uplink transmissions. In some embodiments, the video packet loss data is generated from a mapping using a packet data convergence protocol (PDCP) sequence number and/or a real time protocol (RTP) sequence number and/or a radio link control (RLC) sequence number. The video packet loss data may be generated using a mapping from an RLC packet to a PDCP sequence number to an RTP sequence number. The video packet identifier may be a network abstraction layer (NAL) unit Various other embodiments include apparatuses such as a WTRU or base station configured to implement the methods described herein.

### BRIEF DESCRIPTION OF THE DRAWINGS

A more detailed understanding may be had from the following description, given by way of example in conjunction with the accompanying drawings wherein:

FIG. 1 is an example of a mobile video telephony and video streaming system;

FIG. 2 is an example protocol stack and transmission model;

FIG. 3 depicts a RLC PDU Packet structure showing RLC, PDCP, IP, UDP, and RTP headers;

FIG. 4 depicts basic operations/data flow in RLC AM model;

FIG. 5 depicts basic operations and data-flow at the PDCP sublayer;

FIG. 6 illustrates an exemplary SDU to PDU mapping;

FIG. 7 is a flowchart of one embodiment of a packet-loss detection method that accesses information from RLC, PDCP, and application layers;

FIGS. 8A and 8B depict two predictive encoding, structures, respectively;

FIG. 9 depicts an IPPP predictive encoding structure in which one P frame was lost during, transmission;

FIG. 10A depicts an intra refresh method for reduction of error propagation;

FIG. 10B depicts an embodiment using a Reference picture selection (RPS) method for reduction of error propagation;

FIG. 10C depicts an embodiment using a Reference set of pictures selection (RSPS) method for reduction of error propagation;

FIGS. 11A-B show a comparison of effectiveness of intra Refresh and Reference Picture Selection (RPS) for first and second delays;

FIG. 12 shows a comparison of effectiveness of early feedback combined with RPS vs. late feedback combined with Ultra refresh;

FIGS. 13A-13G depict various possible configurations of mobile video telephony systems in which embodiments of the present invention may be implemented;

FIGS. 14A and 14B depict an embodiment using a DPI-based signaling approach;

FIGS. 15A-15B depict an embodiment using an Application Function based Approach;

FIG. 16 depicts a mobile video telephony system using RPS or RSPS on local link and transcoding and RPS or RSPS at the remote link;

FIG. 17 shows mobile video streaming system using transcoding and RPS or RSPS for error control;

FIG. 18A is a system diagram of an example communications system in which one or more disclosed embodiments may be implemented;

FIG. 18B is a system diagram of an example wireless transmit/receive wilt (WTRU) that may be used within the communications system illustrated in FIG. 18A: and

FIGS. 18C-18E are system diagrams of an example radio access networks and example core networks that may be used within the communications system illustrated in FIG. 18A.

### DETAILED DESCRIPTION

Disclosed herein are methods and systems for early detection and concealment of errors caused by lost packets in wireless video telephony and video streaming applications. In some embodiments, the video information may be carried in RTP packets or packets of any other standardized or proprietary transport protocol that does not guarantee delivery of packets. Early packet-loss detection mechanisms include analysis of MAC- and/or RLC-layer retransmission mechanisms (including HARQ) to identify situations when data packets were not successfully transmitted over the local wireless link. The mechanisms for prevention of error propagation include adaptive encoding or transcoding of video information, where subsequent video frames are encoded without referencing any of the prior frames that have been affected by the lost packets. The use of referenced prior frames in encoding or transcoding operations includes using them for prediction and predictive coding. Proposed packet-loss detection and encoding or nanscoding logic may reside in user equipment (mobile terminal devices), base-stations, or backhaul network servers or gateways. Additional system-level optimization techniques, such as assignment of different QoS levels to local and remote links also are described.

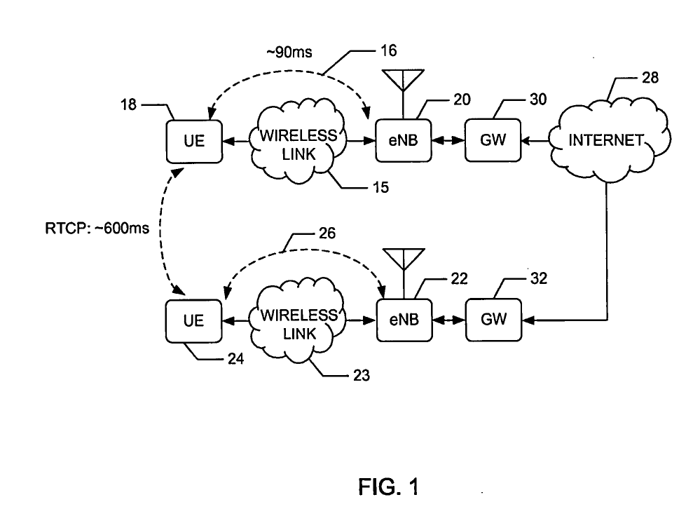

An example of a mobile video telephony and video streaming system operating with RTP transport and RTCP-type feedback is shown in FIG. 1. Transmission of video from a sending UE 18 to a receiving UE 24 involves several communication links. The first or “local” link is a wireless link 15 between a phone (UE) 18 and the base station (eNB) 20. In modern wireless systems, such as LTE, the delay of transmission of a packet between the UE and the base station is bounded, and for real-time/VOIP traffic is usually around 90 ms The packet may be successfully transmitted or lost at the local link 15. A similar delay (and similar possibility of packet loss) is involved in transmission of a packet from the “remote” eNB 22 to UE 24 over “remote” wireless link 26. Between the two eNBs 20 and 22, the packets may pass from the eNB 20 to a gateway node 30, through the interact 28, to another gateway node 32 and then to eNB 22.

When a packet is lost (e.g., at the local link 15, in the Internet 28, or at the remote wireless link 26 through remote network 23), this loss is eventually noticed by user B's application, and communicated back to user A by means of an RTCP receiver report (RR). In practice, such error notification reports usually are sent periodically, but infrequently, e.g., at about 600 ms-1 s intervals. When an error notification reaches the sender (application of user A), it can be used to direct the video encoder to insert an Intra (or IDR) frame, or use other codec-level means to stop error propagation at the decoder. However, the longer the delay between the packet loss and receiver report, the more frames of the video sequence will he affected by the error. In practice, video decoders usually employ so-called error concealment (EC) techniques, but even with state-of-art concealment, a one-second delay before refresh can cause significant and visible artifacts (so-called “ghosting”).

In embodiments described herein, error propagation caused by loss of packets is reduced. The embodiments include methods and systems to provide early packet loss detection and notification functions at the local link 15, and/or use advanced video codec tools, such as Reference Picture Selection (RPS) or Reference Set of Pictures Selection (RSPS) to stop error propagation. The signaling associated with such techniques used at the local link is generically represented by line 16 in FIG. 1 and is described in detail herein. As described herein, techniques including Intra Refresh (IF), reference picture selection (RPS), and reference set of pictures selection (RSPS) may be used to prevent error propagation. Early detection of a packet loss in LTE systems also is described, although similar techniques may be implemented in other wireless infrastructure systems, such as WCDMA, LTE-advanced, etc.

In some embodiments, techniques for enhancing performance of video conferencing systems, such as introducing different QoS modes at the local and remote links, and using transcoder and packet loss detection logic at the remote eNB are used. RTSP/RTP-type video streaming applications are described, as example uses of some of the embodiments described herein.

Early packet loss detection techniques and identification of corresponding video packet loss data will now be described. For convenience of presentation, attention is focused on embodiments using RTP transport and an LTE stack, but alternative embodiments include other transports and link-layer stacks as well.

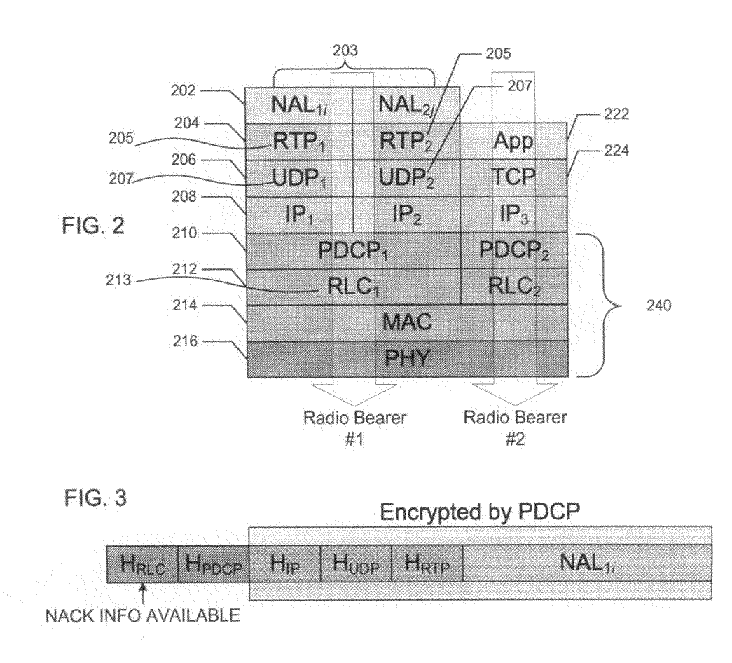

An example of a stack of layers and protocols involved in transmission of video data is shown in FIG. 2, where video data, initially packaged in Network Abstraction Layer (NAL) 202 units 203 are carried using a transport protocol, such as Real-time Transport Protocol (RTP) 204. In the simplest case, each NAL unit 203 is embedded into the payload of a single RTP packet 205. More generally, NAL units 203 may be split and carried as multiple RTP packets 205 or aggregated and transmitted in multiple quantities within a single RTP packet. In turn, RTP packets may be embedded into UDP layer 206 packets 207, which in turn, are embedded in and carried through the system as IP layer 208 packets 209. An application 222 may also use TCP 224 for sending session-related information or types of data that have to be delivered in bit-exact form. As shown in FIG. 2, the LTE data plane 240 includes four sub-layers: PDCP 210, RLC 212, MAC 214, and PHY 216. They are present at both the eNodeB and the UE.

In this embodiment, it may also be assumed that:

1. the PHY/MAC supports multiple radio bearers or logical channels;

2. each class of video traffic has its own radio bearer or logical channel; and

3. each video logical channel can support multiple video applications.

In LTE, for instance, it is the RLC sub-layer 212 that may become aware of lost packets based on its exchange with the MAC layer 214. The frame or frames contained within the lost RLC layer packets should be determined, in order to apply the aforementioned error propagation reduction techniques. Hence, the NAL layer 202 or application layer 222 packet or packets contained within those lost RLC layer 212 packets 213 must be determined. Hence, the contents of the packets in the various layers above and including the RLC layer can be mapped to each other.

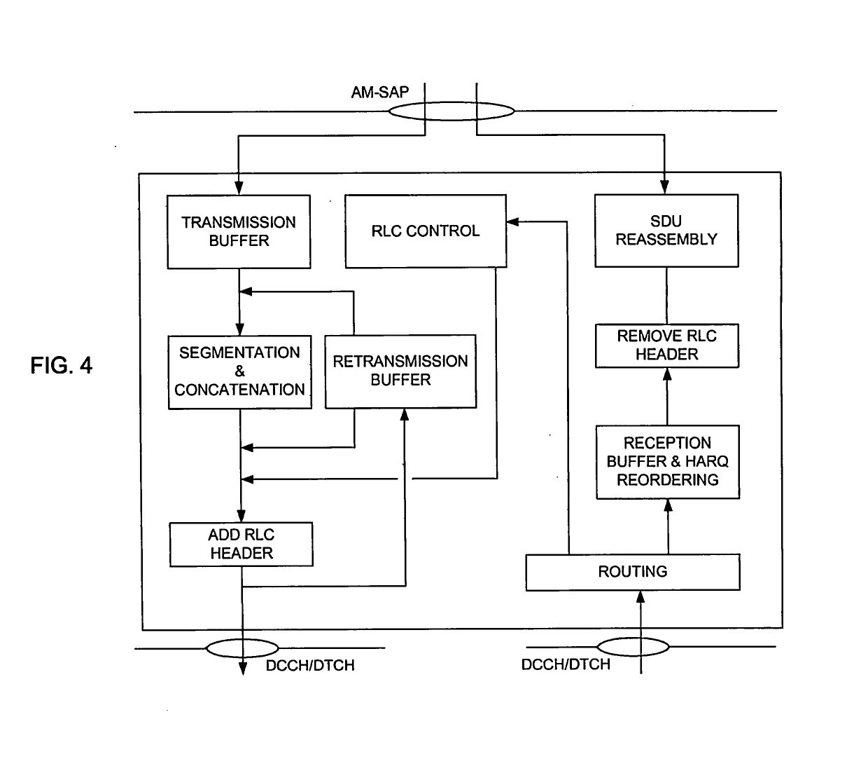

The methods of detecting lost wireless packets and corresponding video packet loss may accommodate situations where PDCP applies encryption to secure data from higher layers, as shown in FIG. 3. Payload encryption makes it impossible and/or inappropriate) to parse headers of upper layers at the RLC sub-layer 212. In order to identify the RTP packets 215 that are lost, in sonic embodiments the PDCP sub-layer 210 may build a table to map RTP packets 204 to PDCP sequence number. In some embodiments, this is done using deep packet inspection at the PDCP layer 210, before ciphering is performed. After identifying which RTP packet is lost, the mapping to lost video NAL units 203 may be done at the application layers 222, 202. When there is a one-to-one mapping from NAL packets 203 to RTP packets 205, the mapping is trivial. When there is fragmentation of packets, the mapping may be achieved, for example, with a table lookup.

Table 1 summarizes operations that may be performed at different layers/sublayers to obtain information about transmission errors, and which NAL units 203 they affect.

TABLE 1
Uses of protocol layer/sublayers for identifying transmission errors

| Protocol | | |
|---|---|---|
| layer/sublayer | Input | Output |
| RLC | Transmission failure | PDCP PDU sequence |
| | indication | number |
| PDCP | PDCP PDU sequence | IP address |
| | number | Port number |
| | | RTP sequence number |
| Application | IP address | NAL packet identifier(s) |
| | Port number | |
| | RTP sequence number | |

The mapping of packets at various layers/sublayers is summarized in Table 2.

TABLE 2
Mapping of Packets (Transmitter)

| Protocol | | | |
|---|---|---|---|
| layer/sublayer | Input | Output | Mapping |
| RLC | PDCP PDU | RLC PDU | Multiple to |
| | | | multiple |
| PDCP | IP packets | PDCP PDU | One to one |
| IP | UDP packet | IP packet | One to one |
| UDP | RTP packet | UDP packet | One to one |
| Application (video | NAL packet | RTP packet | Multiple to |
| encoder) | | | multiple |

Described herein are additional details of actions that are performed at each layer/sublayer.

At the RLC sublayer, packet loss detection and mapping to PDCP sequence number (SN) may be performed. In LTE there are three modes of operation at the RLC layer (as defined in 3GPP TS 36.322), as set forth below:

1. Transparent mode (TM):
No segmentation and reassembly (SAR) of RLC SDUs
No RLC headers added.
No delivery guarantees
Suitable for voice

2. Unacknowledged mode (UM):
Segmentation and reassembly of RLC SDUs
RLC headers added
No delivery guarantees
Suitable for carrying streaming traffic

3. Acknowledged mode (AM):
Segmentation and reassembly of RLC SDUs
RLC headers added
Reliable in-sequence delivery service
Suitable for carrying TCP traffic

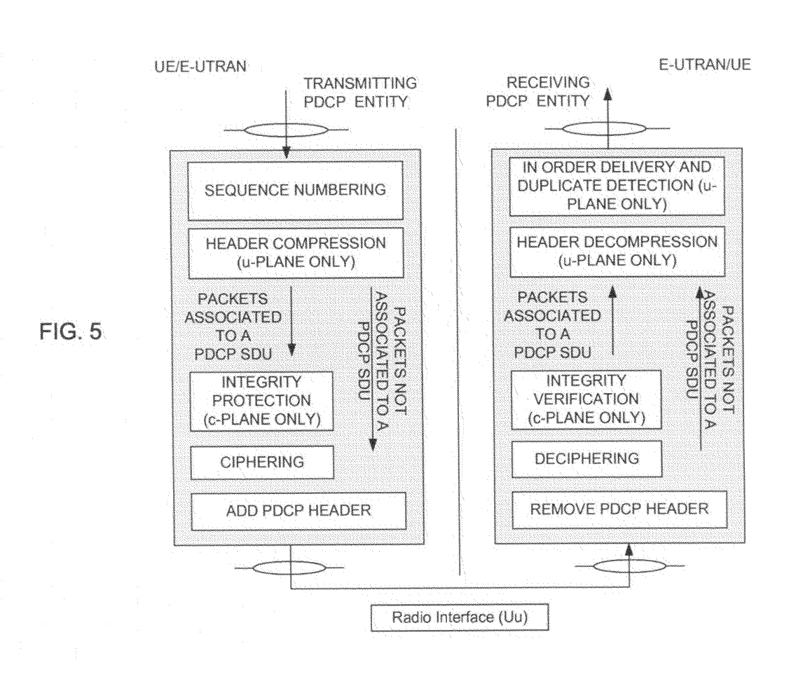

Basic operations/data flow in RLC AM model are shown in FIG. 4.

Retransmission protocols, such as ARQ or HARQ may be counterproductive with video transmissions if used in conjunction with the feedback and error correction techniques in accordance with the present invention. Thus, in one embodiment, wireless packet loss indication may be obtained without invoking ARQ retransmission. There are at least the following approaches for detecting packet loss at the RLC sublayer:
1. Use AM mode but with the parameter maxRetxThreshold (number of ARQ retransmissions) set to zero, which can be configured by the RRC. The ACK/NACK information may be obtained from:
   a. the RLC Status PDUs, received from the peer RLC receiver, which indicate which RLC PDUs have been received correctly and which have not been received successfully (this is supported by the LTE standard, but delay might be larger)
   b. a locally generated status from the MAC transmitter (a HARQ failure on any transport blocks that an RLC PDU corresponds to is considered a loss of the entire RLC PDU). The advantage of this approach is shorter delay, but it requires the mapping from transport block to RLC PDU, which is usually not one-to-one due to segmentation.
2. Use UM combined with locally generated status from the MAC transmitter as described above.

Once an RLC packet has failed transmission, the corresponding PDCP packet(s) may be identified. Segmentation is possible from PDCP to RLC, such that the mapping is not necessarily one to one. Because the RLC SDUs are PDCP PDUs, one may identify the PDCP SN (the sequence number in the compressed header) of PDCP packets that are lost in the transmission from the RLC ACK/NACKs. Note that the RLC sublayer is not able to identify the RTP sequence number because the PDCP ciphers its data SDUs.

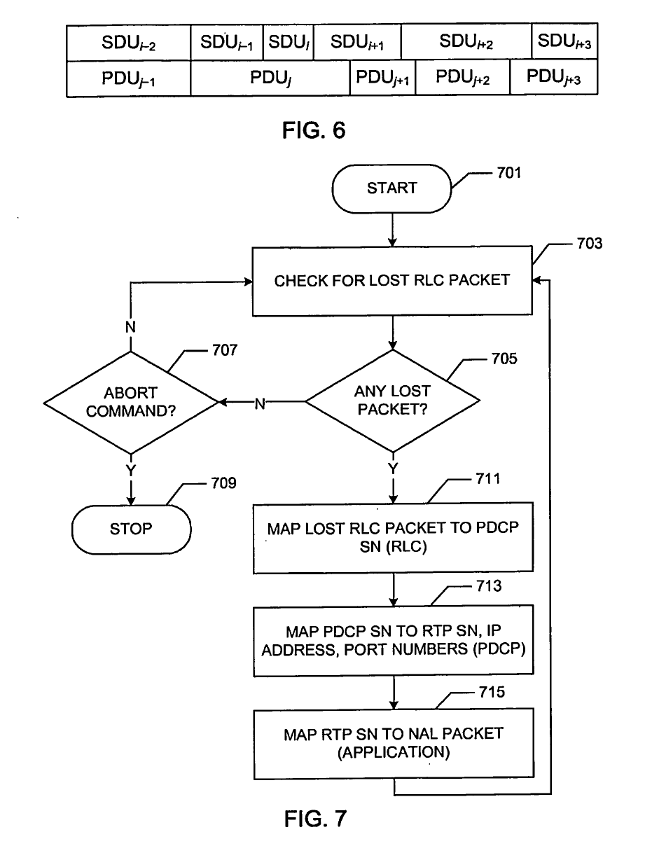

At the PDCP sublayer, lost RTP/UDP/JP packets may be identified. Basic operations and data-flow at the PDCP sublayer are shown in FIG. 5. When a transmission error occurs, the corresponding. PDCP PDUs may be identified by their sequence numbers (SNs). Because only the payload data is ciphered, the RLC sublayer can identify the PDCP SN, but further inspection may not be possible. Therefore, the PDCP sublayer may be involved. The PDCP SDU contains IP, UDP, and RTP headers. Deep packet inspection may be performed to extract IP addresses, port numbers, and RTP sequence numbers. Note that PDCP PDU→RLC SDU mapping is not necessarily one to one. When a transmission fails, a table-lookup may he used in some embodiments in order to identify the corresponding PDCP PDU. The RTP→UDP→IP mapping is one to one. Therefore, it is straightforward to extract the IP address and port numbers from an RTP packet.

At the Application layer 202 or 222, lost NAL units may be identified. After identifying a failed RTP packet, the application layer is tasked to identify the NAL packet that failed transmission. If the NAL→RTP mapping is one-to-one, then identifying the NAL packet is straightforward. If the mapping is not one-to-one, then again a method such as table lookup may be used.

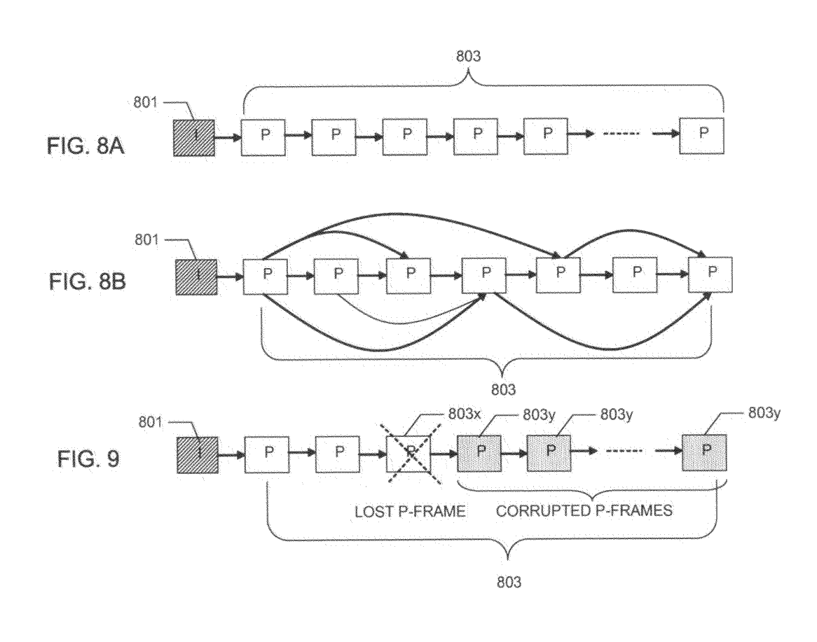

Details of an example table-lookup technique are described herein. FIG. 6 illustrates a general SDU→PDU mapping in which there is segmentation or fragmentation of the PDUs and the mapping of SDUs to PDUs is not necessarily one-to-one (although it is possible that some mappings are one-to-one). Similar mappings may exist in many of the application, transport, and network layers and sublayers. In detecting transmission errors, it is necessary to devise a method for mapping an error PDU to its corresponding SDU(s). One straightforward way to identify an erroneous SDU is by table lookup. For example, in the case illustrated in FIG. 6, one can build the table show below.

TABLE 3
Lookup table for the general mapping illustrated in FIG. 6.

| PDU Index | SDU Index |
|---|---|
| j − 1 | i − 2 |
| J | i − 1 |
| J | i |
| J | i + 1 |
| j + 1 | i + 1 |
| j + 1 | i + 2 |
| j + 2 | i + 2 |
| j + 3 | i + 2 |
| j + 3 | i + 3 |

This table may be built and maintained by the RLC segmentor. It records which SDUs are mapped to which PDUs and vice versa. For example, if a PDU,j, is deemed to have failed transmission, then a table lookup will identify SDUs i−1, i, and i+1 to be the ones that have failed transmission.

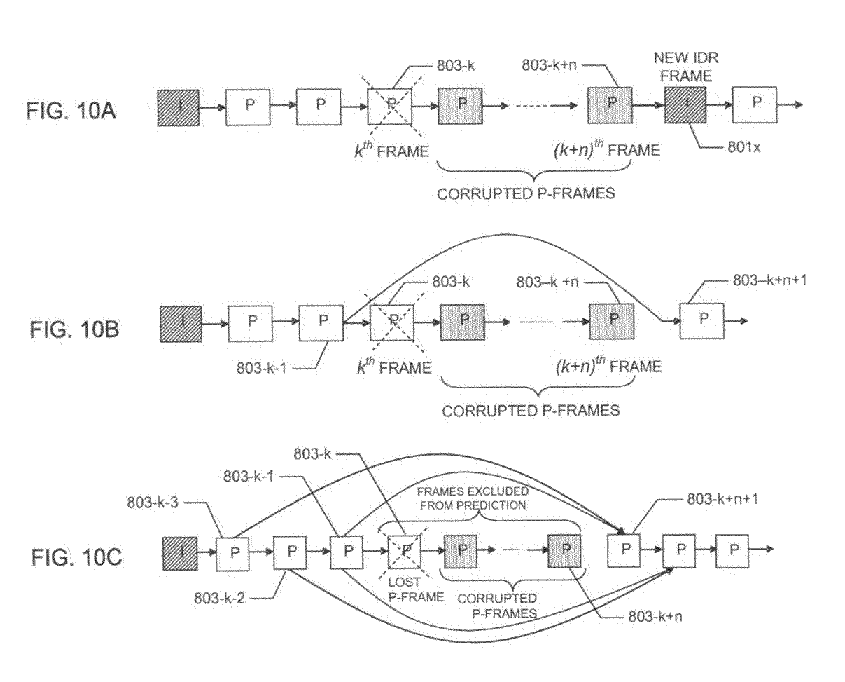

Segmentation is known to exist at the RLC sublayer and the application layer where NAL packets are mapped to RTP packets. Similar methods can be used in both layers. An overall diagram of one packet loss detection procedure is shown in FIG. 7. It utilizes information from the RLC, PDCP, and the application (video) layers. The procedure starts at 701. At 703, the procedure checks for lost RLC layer packets in accordance with the protocol of the particular wireless network, such as LTE. At 705, it is determined if an RLC layer packet has been lost. If not, flow proceeds to 707. At 707, the process checks to see if it has been instructed to cease checking for lost packets. For example, such an instruction may be initiated when it is determined that the data contained in the RLC packets is no longer video data. If so instructed, the process is terminated (709). Otherwise, flow proceeds back to 703 so that the checking for lost packets continues.

If, at 705, it is determined that a particular packet has been lost, then flow proceeds to 711. At 711, the lost RLC layer packet is mapped to the corresponding PDCP layer SN. Then the PDCP SN is mapped to the corresponding RTP layer SN, IP address, and port numbers (713). The IP address discloses the user to which the video data is being sent and the port numbers discloses the application to which the video data is being sent. The RTP SN is then mapped to the corresponding NAL packet (715). The NAL packet identifies the frame or frames that were in the RLC packet that was lost. Flow then returns to 703.

With such early knowledge of the loss of video data and knowledge of the particular frame(s) that were lost, the video encoder in the UE can then implement measures to reduce error propagation at the decoder and/or recover video data, including any of the techniques discussed in detail herein.

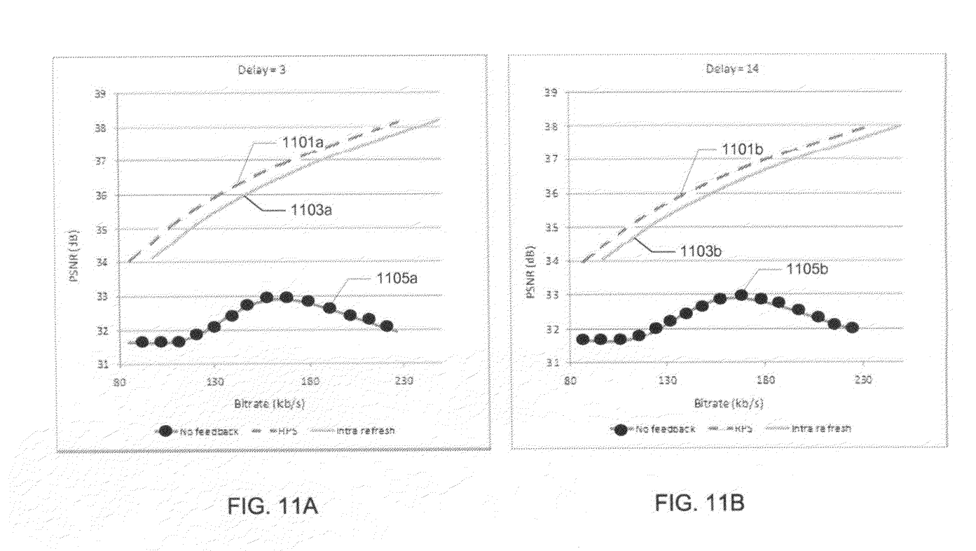

Standard prediction structures will now be described. Video encoding structures in real time applications may include an instantaneous decode refresh (IDR) frame 801 followed by backward prediction frames (P-frames). This structure is illustrated in FIGS. 8A and 8B. FIG. 8A illustrates a classic “IPPP” structure, where every P-frame 803 is predicted from the previous frame, whether it is one of the I frames or P frames. Newer video coding standards, such as H.264, allow the use of multiple (e.g. of up to 16 in H.264) reference frames so that P frames may be predicted from multiple previous frames, thereby providing flexibility in the prediction structure. This coding standard is illustrated in FIG. 8B.

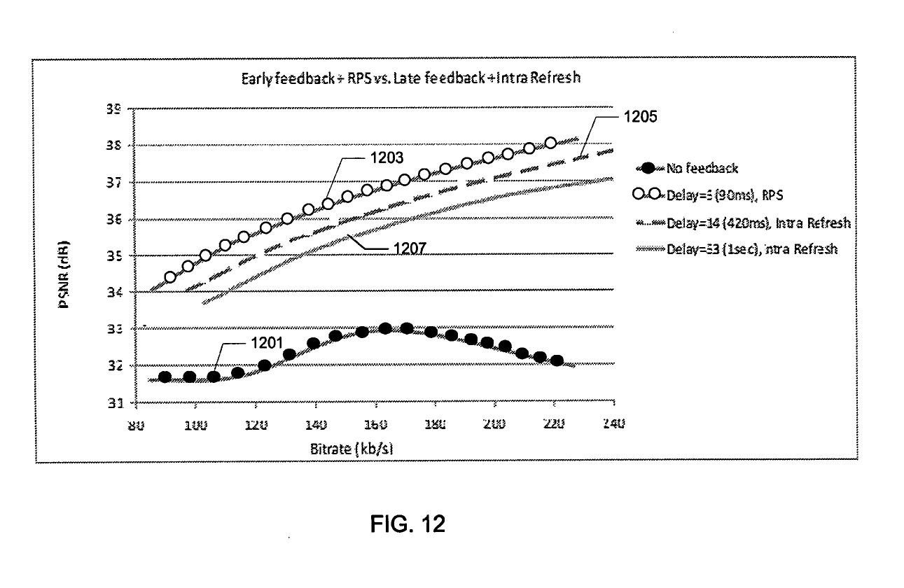

The predictive nature of encoded video makes it susceptible to loss propagation in case of channel errors. Thus, if during transmission, one of the P-frames, such as P frame 803x, is lost, successive P-frames, such as P frames 803y are corrupted, as illustrated in FIG. 9 (typically until the next 1 frame is received). The early wireless packet loss and video packet loss detection and feedback to the encoder described herein is provided to limit error propagation. Specifically, upon receipt of the feedback indicating an error in transmission of a particular frame, the encoder can change the way it encodes the successive frames after receiving the packet loss feedback. The feedback may comprise a positive acknowledgement (ACK) or a negative acknowledgement (NACK), where ACK is used to indicate frames/slices correctly received, while NACK indicates frames/slices that are lost. In existing prior art systems, the NACK/ACK feedback is often accumulated at the receiver before being transmitted as a report to the sender. There often is a delay in transmitting the feedback report.

In video coding, there are two known methods for prevention of error propagation based on feedback: Intra Refresh (IR) and Reference Picture Selection (RPS). Both methods do not add latency to the encoder, and produce standard-compliant bitstreams. These methods may be used in association with many existing video codecs, including H.263 and H.264. In a further embodiment, a Reference Set of Pictures Selection (RSPS) is described that may be specific to H.264 and future codecs using multiple reference pictures.

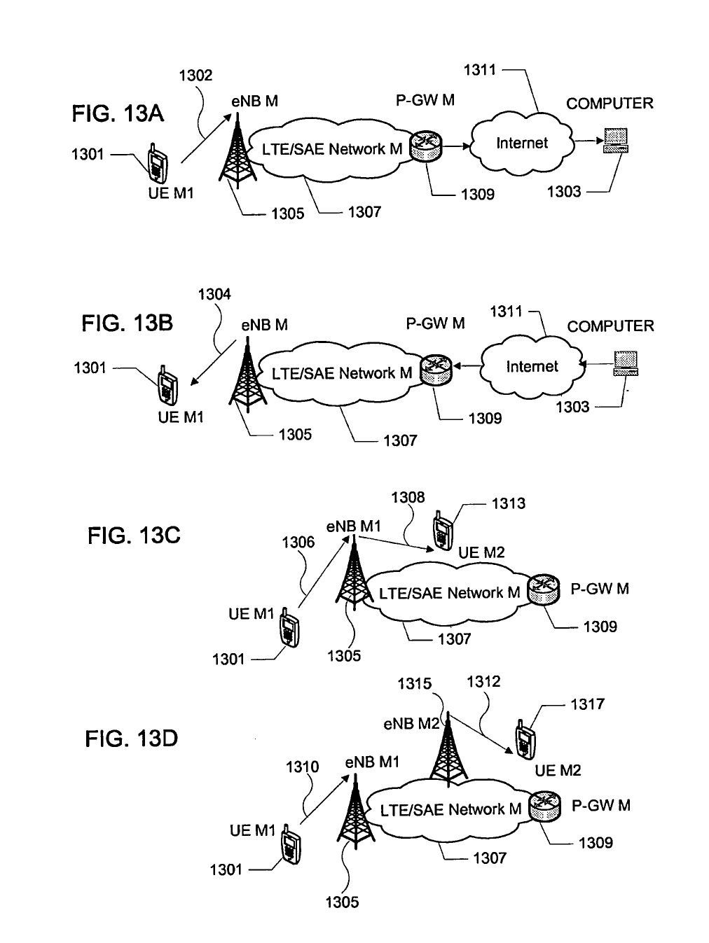

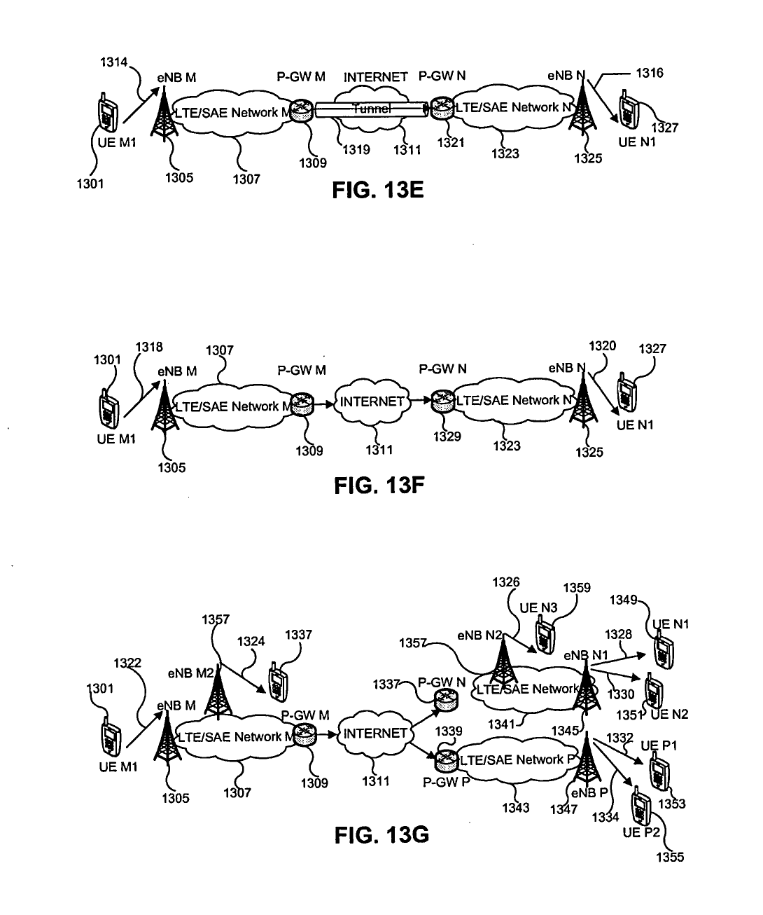

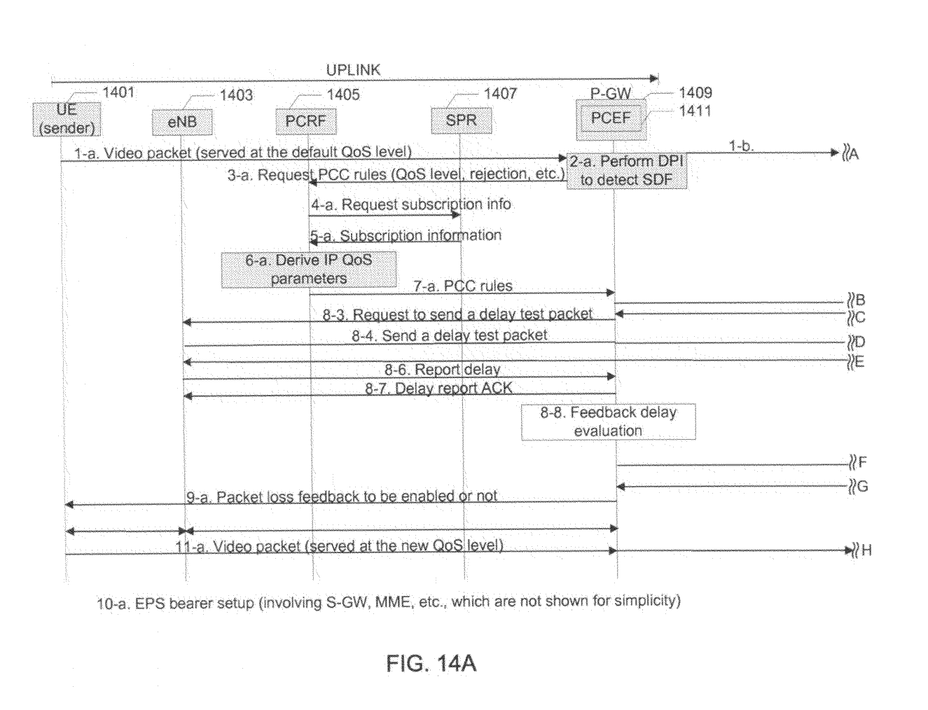

In a first embodiment illustrated in FIG. 10A, an intra Refresh mechanism is used. The packet loss feedback report can comprise ACK/NACK on a MB/slice/frame level basis. FIG. 10A illustrates Intra refresh for reports that contain, as an example, frame level information. Let us assume that the decoder detects the k^{th} frame 803-k to be lost, and transmits feedback information to that effect to the encoder. Further, let us assume that the encoder receives that feedback information after the (k+n)^{th} frame 803-k+n, it encodes the next frame as an t-frame or IDR frame 801x, and successive frames as P-frames. By using an IDR frame, no frames in the past are used for predicting future frames, thereby terminating error propagation at frame 801x, which is n+1 frames after the erroneous frame 803-k, where n essentially comprises the delay between transmission of the erroneous frame and the encoder receiving the feedback that the frame was received erroneously. A drawback of using intra refresh is that it uses IDR frames that consume more bits compared to P-frames.

In a second embodiment illustrated in FIG. 10B, a Reference Picture Selection (RPS) method is used. In RPS, the feedback report contains ACK/NACK information for frames/slices. As in the previous example, the decoder transmits a feedback after detecting a lost k^{th} frame 803-k, and the encoder receives that feedback between the (k+n)^{th} frame and the (k+n+1)^{th} frame. Based on the feedback report, the encoder finds the most recent frame that was successfully transmitted in the past, e.g., frame 803-k−1, and uses it to predict the next frame, 803-k+n+1.

RPS uses a predictive P-frame instead of Infra (IDR) frame to stop error propagation. In most cases, P-frames use many fewer bits than I frames, which leads to capacity savings.

In further embodiments, aspects of the IR and RPS approaches may be combined. For instance, the encoder may encode the next frame in both IDR and P-predicted modes, and then decide which one to send over the channel.

In a further embodiment illustrated in FIG. 10C, a Reference Set of Pictures Selection (RSPS) method may be used. This embodiment is a generalization of the RPS method, allowing its use with multiple reference picture prediction. For example, it can be used with H.264 codec. This technique is referred to herein as Reference Set of Pictures Selection (RSPS). In the RSPS method, alter receiving the NACK feedback report, e.g., a NACK report received between the encoder's transmission of frames 803-k+n and 803-k+n+1 indicating that frame 803-K was lost, successive frames, e.g., frames 803-k+n+2 and 803-k+n+3, are predicted using any possible subset of the past delivered and uncorrupted frames, e.g., frames 803-k−1, 803-k−2, 803-k−3. In some embodiments, such as those based on H.264 codec implementations, a further constraint may be imposed where such frame subsets must be in the H.264's decoder reference picture buffer.

Due to the flexibility in prediction, RSPS may yield better prediction and thereby better rate-distortion performance over the IF and RPS methods.

In some encoding techniques, each frame may be further spatially partitioned into a number of regions called slices. Some embodiments of the RSPS technique may therefore operate on a slice level. In other words, it may be only subsets of frames that are removed from prediction. Such subsets are identified by analyzing information about packets/slices that were lost, and the chain of subsequent spatially aligned, slices that would be affected by loss propagation.

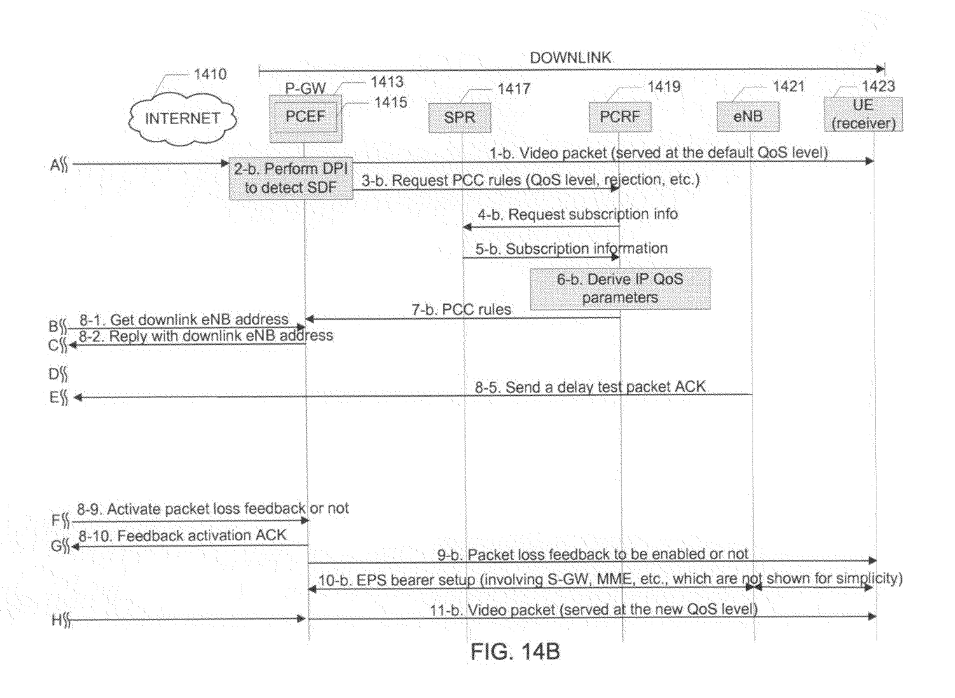

The effectiveness of the above described embodiments were tested using a simulated channel with 10e-2 packet error rate (which is typical for conversationat/VOIP services in LTE), and using notification and IR, RPS, and RSPS mechanisms in the encoder. We have used an H.264 standard-compliant encoder, and implemented RPS and RSPS methods by using memory management control operation (MMCO) instructions. Standard video test sequence “Students” (CIF-resolution, 30 fps), was looped in forward-backward fashion to produce an input video stream for the experiments. The results are shown in FIGS. 11A and 11B for notification delays of 3 frames (90 ms) and 14 frames (420 ms), respectively, which show a comparison of effectiveness of Intra Refresh (see lines 1101a and 1101b) and Reference Picture Selection (RPS) (see lines 1103a and 1103b) techniques as compared to using no error feedback at all (see lines 1105a and 1105b). Tests were performed using standard “Students” test sequence (CIF, 30 fps), encoded using an H.264 video encoder and transmitted over a system with 10e-2 packet error rate.

Based on these experiments, the following observations are supported:
1) Both techniques offer substantial improvement in quality compared to transmission of encode video without feedback: 4-6 dB gain is observed.
2) RPS technique seems more effective than IR: 0.2-0.6 dB additional gain is observed.
3) The RPS technique is more efficient when notification delay is small: in this experiment, we observe 0.5-0.6 dB additional gain as compared to IR technique with 3-frames (90 ms) delay, and only 0.2-0.3 dB additional gain when delay increases to 14 frames (420 ms).
4) Feedback delay also affects quality/effectiveness of both techniques: the shorter the delay, the more effective both techniques.

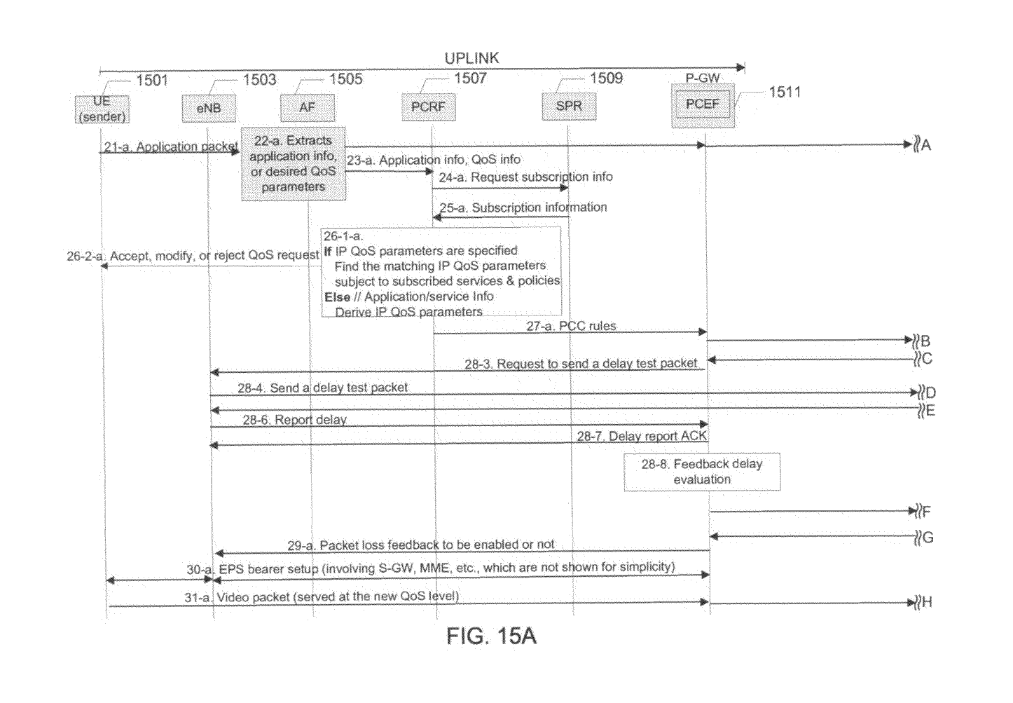

Sonic of the embodiments described herein use a combination of two techniques: (i) Detect packet loss as early as possible, and if it happens at local link—signal it back to the application/codec immediately; and (ii) Prevent propagation of errors caused by lost packets by using RPS or RSPS techniques. The gain of using the combined technique as compared to conventional approaches, such as RTCP feedback combined with Intra refresh is analyzed in FIG. 12, which shows a comparison of effectiveness of early feedback combined RPS versus other approaches. In the data of FIG. 12, we assume that packets are lost at the local link, and with 10e-2 probability. Line 1201 represents the baseline PSNR data for no feedback, line 1203 represents the data for a system using the early feedback technique with RPS of the present invention for a delay of 3 frames (90 ms), line 1205 represents the data for a system using the early feedback technique with RPS of the present invention for a delay of 14 frames (420 ms), and line 1207 represents the data for a system using the early feedback technique with RPS of the present invention for a delay of 33 frames (about 1 second).

It can be observed that, if RTCP feedback delay is increased from 30 ms to 420 ms delay, gain improvement for this embodiment drops by about 0.6-0.7 dB gain. When RTCP feedback is further increased to 1 second, the PSNR drop widens to about 1.0-1.2 dB as compared to a delay of 30 ms.

As can be seen by the above-described results, the methods and systems described herein may deliver appreciable improvements in visual quality in practical scenarios. In average PSNR metric, improvements may be in the 0.5-1 dB range. Perceptually, the improvements will be apparent because early feedback will prevent artifacts such as “frozen” pictures or progressively increasing “ghosting” caused by the use of error concealment logic in the decoder.

Numerous embodiments are described for providing information about packet loss at the local link to the encoder and may include an interface for communication of information about packet loss to the encoder. In one embodiment, the encoder, before encoding each frame, may call a function that returns the following information: (1) an indicator that identifies if any of the previously transmitted NAL units were sent successfully (or not sent successfully); and (2) if some NAL units were not sent successfully, the indices of those NAL units that have been lost recently. The encoder may then use RPS or RSPS to cause prediction to be made from a frame Or frames that were sent before the first frame affected by the packet loss.

In one embodiment, such an interface may be provided as part of Khronos' OpenMAX DL framework. In alternative embodiments, the set of information exchanges between the RLC and the application layer are standardized as normative extensions in 3GPP/LTE.

In a further embodiment, a custom message in RTCP (for example an APP-type message) is used to signal local link packet-loss notification to the encoder. This communication process may be encapsulated in the framework of existing IETF protocols.

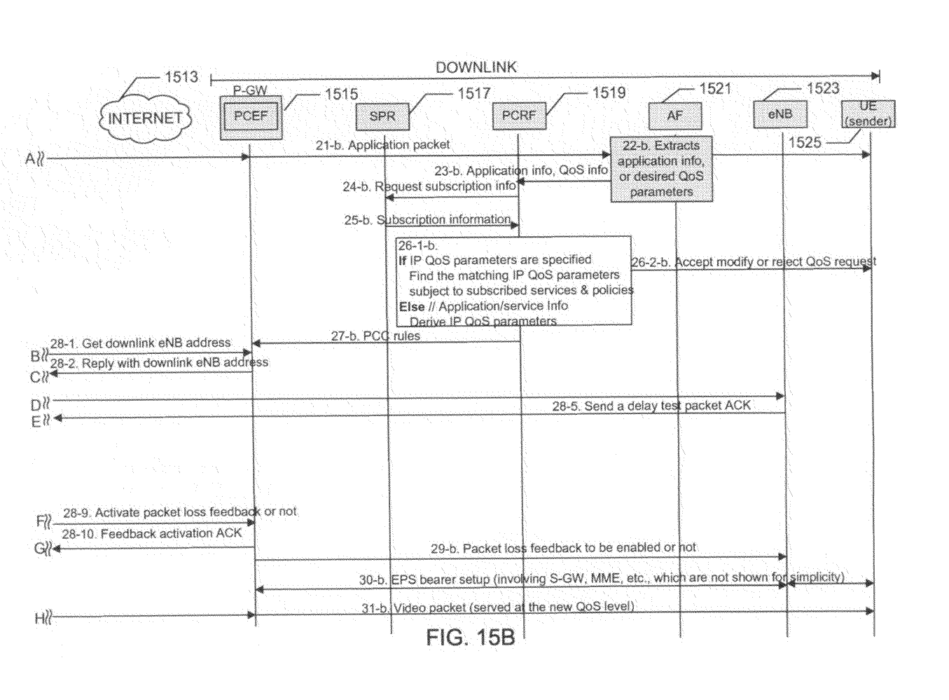

Various applications in mobile video telephony are depicted in FIGS. 13A-13G, which show seven possible configurations of mobile video telephony systems. Most scenarios involve more than one wireless link. The terms “local” and “remote” are used to refer to the distance between the video encoder and the link in question.

In some embodiments, feedback and loss propagation prevention methods described herein may be applied to the “local link”. In some embodiments, these may be combined with various methods to reduce the effect of errors on “remote links”. These methods may include one or more of (i) setting different QoS levels to the remote and local wireless links; and (ii) using transcoding of video coupled with the early packet loss detection and RPS or RSPS technique at the remote base station.

Different QoS levels may be determined and set through a negotiation as described in U.S. Provisional Application Ser. No. 61/600,568, entitled “Video QOE Scheduling”, filed Feb. 17, 2012, the contents of which are incorporated herein by reference.

Using a higher QoS at the remote link will tend to cause most transmission errors to occur at the local/weaker link, thereby minimizing lost packets at the more distant, remote link, where the delay between transmission of a lost packet and the feedback of such error information to the encoder may be too long to permit error propagation reduction techniques to provide the desired picture quality.

QoS Differentiation for Local Link and Remote Links will be discuss with respect to the scenarios depicted in FIGS. 13A-13G, and the potential for improving the system performance by assigning different QoS to local and remote links is assessed.

FIG. 13A depicts a first scenario in which there is only one wireless link 1302 (i.e., the local uplink 1302), between the encoder in the node 1301, which is transmitting in this example, and the remote node 1303, which is receiving/decoding node in this example. The nodes/elements between the nodes 1301 and 1303 in the example of FIG. 13A include a base station 1305, an LTE/SAE network infrastructure 1307, a gateway 1309 between the LTE/SAE network and the Internet, and the Internet 1311. This scenario is trivial because there is no wireless downlink.

Scenario 2 shown in FIG. 13B also has only one wireless link and is substantially the same as scenario 1 of FIG. 13A, except that node 1301 is the receiving/decoding node and node 1303 is the transmitting/encoding node. In this scenario, there also is only one wireless link 1304, but it is the remote downlink to the receiver. Differentiation between uplink and downlink is not needed (or not applicable) because there is only one wireless link. However, it still may be useful to assure that the QoS level for the wireless downlink 1304 is of sufficient quality to minimize packet losses since the wireless downlink may be far away from the video encoder, and any feedback mechanism may incur excessive delay.

In scenario 3 depicted in FIG. 13C, there are two wireless links 1306, 1308, between the transmitting node 1301 and the receiving node 1313. Both wireless links 1306, 1308 are within the same cell. In this case, because the downlink is close to the video encoder, the feedback delay will be short and the same packet loss detection scheme and video encoder adaptation scheme used for the uplink can be used here as well.

In scenario 4 depicted in FIG. 13D, again, there are two wireless namely, (1) a local uplink 1310 between transmitting node 1301 and base station 1305 and (2) a remote downlink 1312 between base station 1315 and receiving node 1317. However, in scenario 4, the transmitting and receiving nodes 1301 and 1317 are located in different cells (represented by different base stations 1305 and 1315, respectively) of the same LTE/SAE network 1307. The delay from the wireless downlink to the video encoder of transmitting node 1301 may or may not be too long for practical use of feedback and error propagation minimization in accordance with the present invention.

In scenario 5 depicted in FIG. 13E, there are two wireless links, namely, (1) wireless local uplink 1314 between node 1301 and base station 1305 and (2) wireless remote downlink 1316 between base station 1325 and node 1327, and they are located in different LTE/SAE networks, namely, networks 1307 and 1323, respectively. These two networks are connected, through their respective gateways 1309 and 1321, via a tunnel 1319 through the Internet 1311. In this scenario, due to the same reasons as in scenario 4 (it may he too much delay between the downlink 1316 and the encoder in transmitting node 1301), it may not be appropriate to use a feedback mechanism to handle packet losses in the wireless downlink.

Scenario 6 depicted in FIG. 13F is almost identical to scenario 5 depicted in FIG. 13E, except that there is no tunnel between the two LTE/SAE networks. Particularly, there are two wireless links, namely, (1) wireless local uplink 1318 between node 1301 and base station 1305 and (2) wireless remote downlink 1320 between base station 1325 and node 1327 located in different LIE/SAE networks 1307 and 1323, respectively. Since there is no customized tunneling packet format available, additional signaling between the LTE/SAE networks 1307 and 1323 may be needed for QoS provisioning in the wireless downlink 1320.

Finally, scenario 7 depicted in FIG. 13G is the most generic scenario. There is more than one destination for each video packet uploaded from node 1301 to the first LTE/SAE network 1307 through uplink 1322 to base station 1305. The destinations are distributed in more than one LTE/SAE network. Specifically, in this example, there is: (1) a first downlink 1324 between base station 1357 and first receiving node 1337 in first network 1307; (2) a second downlink 1326 between base station 1357 and node 1359 in another LTE/SAE network 1341 (connected to first network 1307 through Internet 1311 via appropriate gateways 1309 and 1337). Two more receiving nodes 1349 and 1351 in a different cell of second network 1341 receive the video data through a separate base station 1345 through wireless downlinks 1328 and 1330, respectively. Finally, two more receiver nodes 1353 and 1355 in a third network 1343 (in communication with the first network 1307 via the Internet 1311 and appropriate gateways 1309 and 1339) receive the video data over yet further wireless downlinks 1332 and 1334 with base station 1347 in third network 1343. In this scenario, in addition to the large delays between the video encoder (node 1301) and at least most of the various wireless downlinks, since there are multiple wireless downlinks and they may experience different packet loss conditions, in general, it is not possible to handle the packet losses by adapting the single video encoder.

In summary, the large delay between the wireless downlinks and the video encoder may apply to Scenarios 4-7 of FIGS. 13D-13G. For example, in Scenario 6 of FIG. 13F, the feedback delay can be prohibitively long, on the order of 600 ms as opposed to 90 ms in the ease of the uplink. In order to resolve this issue, in one embodiment a higher QoS level may be used for the remote downlink 1320, which may result in a more robust ARQ mechanism at the remote downlink. This way, the packets will be better protected without incurring excessive delay.

Techniques for setting different QoS levels in LTE are now described with respect to two exemplary embodiments that enable such QoS differentiation between wireless uplink and wireless downlink Each approach may involve any (or none) of the following three functions: (i) the network(s) determine the QoS level for the uplink; (ii) the network(s) determine whether a feedback mechanism for packet loss detection will be used at the uplink and downlink; and, (iii) the network(s) determine the QoS level for the downlink. For the uplink, in general, the feedback mechanism is recommended.

The current 3GPP specification defines nine QoS levels (QCI values). Each QoS level is recommended for a number of applications. Simply following the recommendation in the 3GPP specification, the video packets transmitted over the downlink will receive the same QoS level as the video packets over the uplink, because the application is the same on the uplink and on the downlink.

However, some embodiments may leverage the PCC capability of the current 3GPP specification to enable QoS differentiation between uplink and downlink. In one such embodiment, the following procedures may be performed:
1. The network operator uploads policies to the network to dictate which QoS level is to be used for uplink traffic and for downlink traffic for a type of video application (and possibly other applications);
2. The network detects the video traffic flow and determines its application type (video streaming, video conference, etc.) and uplink/downlink direction;
3. The network refers to the policies to determine which QoS level is to be applied to the detected video traffic flow.

One embodiment may use deep packet inspection (DPI), and an alternative embodiment may use application functions to determine application type, both of which are described in further detail below.

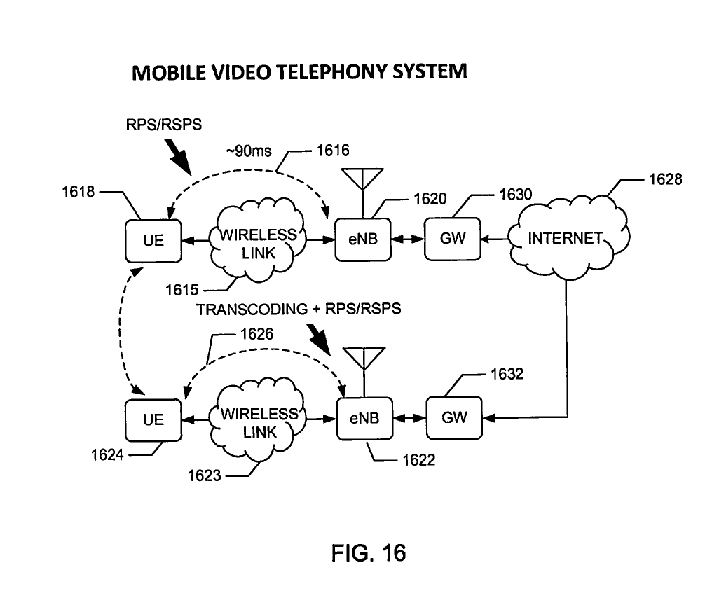

FIGS. 14A and 14B comprise a diagram illustrating signal flow and operation for an embodiment using a DPI-based approach. It is understood that many variations of the overall method as well as of the particular steps are possible. The uploading of the policies to the PCRF by the network operator is not depicted, as it may not occur frequently. The policies may contain information about (1) the desired QoS level for uplink traffic and downlink traffic for each subscription category and (2) the conditions under which a feedback mechanism can be used to provide information about packet losses. These conditions may relate to the delay between the sender UE (video encoder) and the wireless downlink.

Referring now to FIGS. 14A and 14B, which collectively comprise a signal flow and operation diagram in accordance with one exemplary DPI-based approach, the transmitting UE 1401 sends a video packet. The video packet traverses the local LTE network through the local eNB 1403 to the local network's P-GW 1409. This is represented at 1-a in the FIG. The local P-GW 1409 sends the packet through the Internet 1410 to the corresponding P-GW 1411 of the remote network, as shown at 1-b. The P-GW 1411 of the remote network forwards the packet through the remote LTE/SAE network in the downlink direction, as shown at 1-c.

At the P-GW 1411 or the uplink, DPI is performed to detect the SDF, as shown at 2-a. Similarly, DPI is used at the P-GW of the downlink, as shown at 2-b.

The P-GWs 1409 and 1411 then each send a message 3-a and 3-b, respectively, to their PCRFs 1405 and 1419 requesting the PCC rules associated with the SDF. The PCC rules may include the QoS level, whether to reject the SDF or not, etc.

The PCRFs 1405, 1419 contact their respective SPRs 1407 and 1417 to get the subscription information associated with the UE of the detected SDF, as shown at 4-a and 4-b.

The SPRs 1407 and 1417 reply with the subscription information, as shown at 5-a and 5-b.

The PCRFs 1405, 1419 use the subscription information and the policies uploaded by the network operators to derive the PCC rules for their respective SDFs, as shown at 6-a and 6-b. However, the derived PCC rules may be different in the two LTE/SAE networks, because the desired QoS levels for uplink and downlink may be different.

The PCRFs 1405, 1419 send the PCC rules to their respective P-GWs 1409, 1411, as shown at 7-a and 7-b.

Next, it will be determined if a feedback mechanism will be employed for communications between the sending and receiving UEs 1401 and 1423. This may involve some or all of the steps labeled 8-i through 9-a shown in FIGS. 14A and 14B. Not all of these steps will necessarily be performed depending on the particular situation.

While, in one embodiment, it is possible to make a decision as to whether to employ feedback in the uplink and/or downlink simply by categorizing the scenario in question into one of the seven scenarios as depicted in FIGS. 13A-13G, this may not lead to optimal operation in all cases. For example, in scenario 6 depicted in FIG. 13F, it is quite possible that UE 1301 is close to P-GW 1309, that the path between the P-GW 1309 and P-GW 1313 is short, and that P-GW 1311 may be close to UE 1327, and, therefore, it is advisable to use feedback in the downlink. Thus, FIGS. 14A and 14B illustrate a more robust embodiment. Particularly, in this embodiment, the P-GW 1409 in the uplink LTE/SAE network requests the address (e.g., IP address) of the eNB for the wireless downlink, as shown at 8-1. This request may include the following information: (1) the IP address of the UE receiver 1423 and (2) the IP address of the P-GW 1409 that sends the message 8-1.

Next, the P-GW 1413 in the downlink LTE/SAE network may forward the request to its own subscription service (not shown) and receive in response the IP address of the eNB 1421 that currently serves the UE receiver 1423 (also not shown), and then send a reply, message 8-2, with the IP address to the requesting P-GW 1409.

Next, in the uplink LTE/SAE network, the P-GW 1409 sends a request message 8-3 to the uplink eNB 1403 asking it to send a delay test packet to the eNB 1421 in the downlink network. This message may contain the address of the eNB 1421 in the downlink network.

In response, eNB 1403 sends a delay test packet 8-4 to the downlink eNB 1421. The delay test packet contains at least (1) its own address, (2) the address of the downlink eNB, and (3) a timestamp. The test packet may be an ICMP Ping message.

The downlink eNB 1421 sends back an ACK 8-5. The ACK message may contain the following information: (1) the address of the uplink eNB; (2) the address of the downlink eNB; (3) a time stamp when the ACK is generated; and (4) a time stamp copied from the delay test packet

Next, the uplink eNB 1403 calculates the delay between itself and the downlink eNB 1421 and sends a report message 8-6 to the uplink P-GW 1409.

The uplink P-GW 1409 sends back an ACK message 8-7 to the uplink eNB 1403 to confirm the reception of the delay report. The report may contain the following information: (1) the address of the uplink P-GW; (2) the address of the uplink eNB; and (3) the address of the downlink eNB.

The uplink P-GW 1409 then evaluates the feedback delay based on the delay reported from the uplink eNB and compares the feedback delay with the PCC rules. It then decides whether a feedback mechanism for detecting packet losses should be used for the uplink and/or the downlink.

Then the uplink P-GW 1409 informs the downlink P-GW 1413 of its decision whether to use a feedback mechanism in message 8-9. Message 8-9 may have the following information: (1) the address of the uplink P-GW; (2) the address of the downlink P-GW; (3) the address of the uplink eNB; (4) the address of the downlink eNB; (5) the address of the UE sender; (6) the address of the UE receiver; (7) the application type; and (8) a message ID.

The downlink P-GW 1413 replies with an ACK 8-10, which may contain the same type of information contained in message 8.9. Additionally, it may contain its own message ID.

Note that, in the case the two UEs are in the same LTE/SAE network, Messages 8.1, 8.2, 8.9, and 8.10 will not be used.

The uplink and downlink P-GWs 1409 and 1412 send messages 9-a and 9-b, respectively, to the sending and receiving eNBs 1401 and 1423 indicating whether the feedback mechanism for detecting packet losses on the respective wireless link will be enabled or not.

In one embodiment, feedback is always enabled for the uplink. For the downlink, on the other hand, the decision should depend on the actual delay between the sender UE 1401 (where the video encoder is located) and the wireless downlink in question.

Next, each P-GW 1409, 1413 initiates the set up of the EPS bearer, and assigns a QoS level to the EPS bearer based on the PCC rules received from the PCRF. This series of events is labeled as 10-a and 10-b for the uplink and downlink networks, respectively, in FIGS. 14A and 14B.

Finally, if the sending UE 1401 sends a video packet, this video packet will be served at the new QoS levels in the LTE/SAE networks. These events are labeled as 11-a and 11-b, respectively, in FIGS. 14A and 14B.

Alternately, an application function-based approach may be used. For instance, in the DPI method, the use of encryption may render it quite difficult for the P-GW to obtain the information from the passing video packets that is needed to determine the desired QoS level. In an application function-based approach, the P-GW does not inspect data (video) packets. Instead, the application function extracts necessary information from the application used by the UEs, and passes that information to the PCRF. For example, an application function could be the P-CSCF (Proxy-Call Service Control Function) used in the IMS system. The application signaling may be carried by SIP. A SIP INVITE packet (RFC 3261) payload may contain a Session Description Protocol (SDP) (RFC 2127) packet, which in turn may contain the parameters to be used by the multimedia session.

In some embodiments, attributes for the SDP packet are defined to describe the desired QoS levels for the uplink traffic and downlink traffic and the delay threshold for triggering the packet loss detection feedback mechanism. For example, per the SDP syntax (RFC 2327):

a=uplinkLoss:2e-3

a=downlinkLoss:1e-3

a=maxFeedbackDelay:2e-1

The meaning of the above is:

Tolerable uplink packet loss is 2×10-3

Tolerable downlink packet loss is 1×10-3

Maximum feedback delay for any packet loss detection is 2×10-1 sec or 200 ms

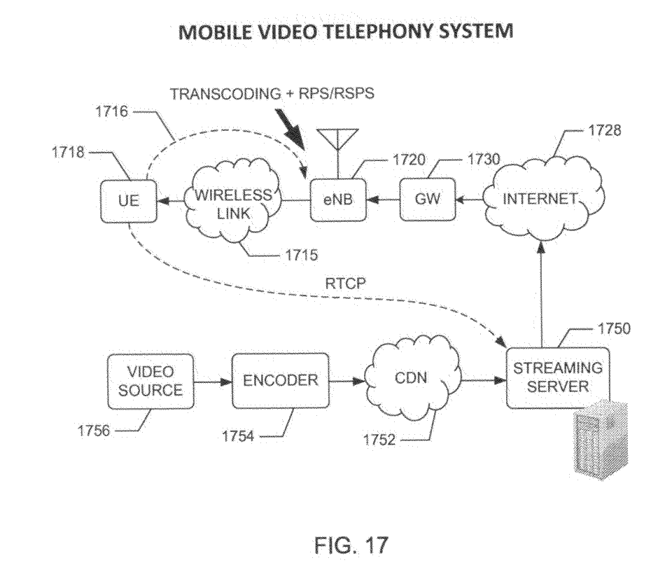

Signaling, and operation in accordance with one exemplary embodiment of an application function-based approach is depicted in FIGS. 15A and 15B. Many variations are possible.

The uplink UE 1501 sends an application packet, which could be a SIP INVITE packet described above with attributes defined by the uplink UE. This packet traverses both LTE/SAE networks. These events are labeled as 21-a and 21-b in the uplink and downlink networks, respectively.

The AF 1505 and 1521 in each of the uplink and downlink networks extracts the application information and possibly QoS parameters from the application packet. These events are labeled as 22-a and 22-b, respectively.

The AFs 1505 and 1521 send the extracted application information and QoS information to their respective PCRFs 1507 and 1519, as shown at 23-a and 23-b, respectively.

As in the DPI-based embodiment of FIGS. 14A and 14B, the PCRFs 1507, 1519 contact their respective SPRs 1509 and 1517 to get the subscription information associated with the UE of the detected SDF, as shown at 24-a and 24-b, and the SPRs 1509 and 1517 reply with the subscription information, as shown at 25-a and 25-b.

Next, using the uplink network as an example, if QoS parameters are specified, the PCRF 1507 will find the matching QoS level (e.g., QCI value) for that SDF, as shown at 26-1-a, and may send a message 26-2-a to the UE 1501 to notify it of the result of the QoS request. Otherwise, the PCRF will derive the QoS level.

The same occurs in the downlink message, as illustrated by operation 26-1-b in which PCRF 1519 finds the matching QoS level and may send a message 26-2-b to the downlink UE 1525 notifying it of the result of the QoS request.

Messages 26-2-a and 26-2-b may have the following, information: (1) address of the UE (2) identifier of the SDF, e.g., destination IP address, source port number, destination port number, protocol number, (3) whether the QoS request is accepted or not; and (4) if the QoS request is rejected, the recommend QoS for use.

The remaining signaling and operations 27-a, 27-b, 28-1, 28-2, 28-3, 28-4, 28-5, 28-6, 28-7, 28-8, 29-a, 29-b, 30-a, 30-b, 31-a, and 31-b are essentially the same as the corresponding signaling and operations in FIGS. 14A-14B, namely, 7-a, 7-b, 8-1, 8-2, 8-3, 8-4, 8-5, 8-6, 8-7, 8-8, 8-9-a, 8-9-b, 10-a, 10-b, 11-a, and 11-b, respectively.

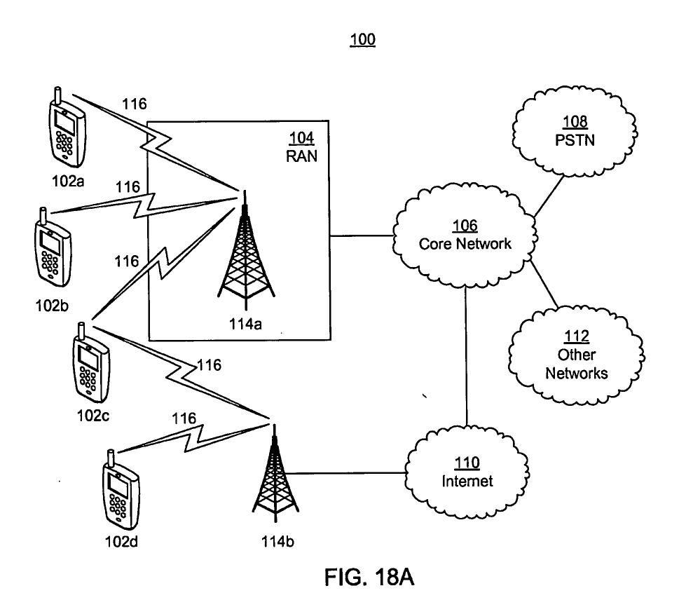

Transcoding for prevention of error propagation at remote links also may be used in some embodiments, including RPS or RSPS operations at the remote base station. A system diagram illustrating an embodiment of such an approach is shown in FIG. 16.

Similarly to the system shown in FIG. 1, in the system of FIG. 16, transmission of video from a first UE 1618 to a second UE 1624 may involve several communication links, including, for instance, a first or “local” wireless link 1615 between the first user's UE 1618 and the local base station (eNB) 1620, a link from the eNB 1620 to the first network's wireless network gateway 1630 and, therethrough, to the gateway 1632 of a remote network via the Internet 1628, and, in that remote network, to an eNB 1622 and over a wireless link 1623 to the second user's UE 1624.

The techniques described hereinabove for early detection of packet loss and error propagation reduction may he used at the local wireless link 1615 as previously discussed and are generically represented by line 1626 in FIG. 16. However, the transmission delay between the remote wireless link 1623 and the source UE 1618 may be too long in many cases to simply extend those techniques to the remote link.

In such cases, similar early packet loss detection and error propagation reduction techniques to those described above primarily in connection with local wireless links may be applied at the remote link 1623. However, in these embodiments, the remote base station performs transcoding of the video packets it receives as input and encoding operations are performed between the remote base station 1622 and the receiving UE 2624. These operations are represented by line 1626 in FIG. 16.

In some embodiments, transcoding at the remote base station 1622 may be invoked only if and when packets are lost. In the absence of packet loss, the base station 1622 may simply send the incoming sequence of RTP packets on to the UE 1624 over the wireless link 1623.

Then, when packet loss is detected, the base station may prevent loss propagation by commencing transcoding. In one embodiment, upon detection of packet loss, the base station 1622 transcodes the next frame/packet by using RPS or RSPS to the last successfully transmitted frame. To prevent ghosting, the frames following the lost frame (until the next IDR frame is received) are transcoded as P-pictures, referring to prior frames that were successfully transmitted. In this transcoding process, many encoding parameters, such as QP levels, macro-block types, and motion vectors can be kept intact, or used as a good starting point to simplify the decision process and maintain relatively low-complexity in the process.

Coupled with RPS/RSPS (see, e.g., 1616) on the local link 1615, this technique should be sufficient to combat errors introduced by wireless links. The global RTCP feedback still may be used to deal with cases when packets are delayed or lost due to congestion on the wired portion of the communication chain.

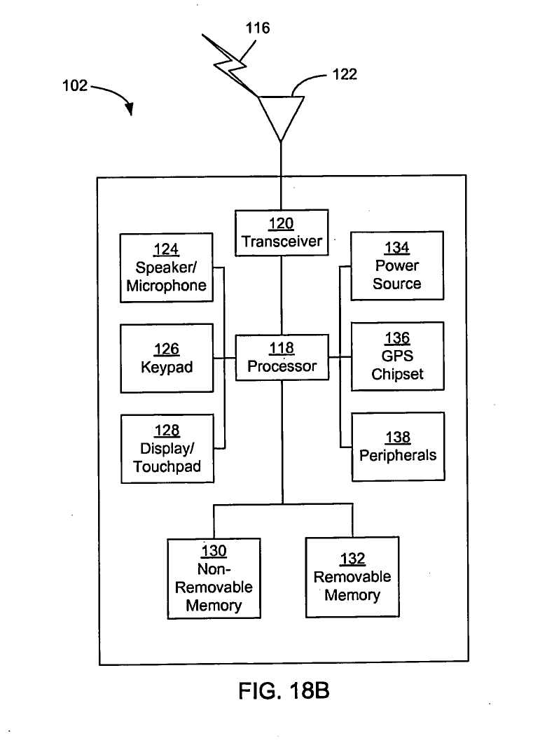

As shown above, early packet loss detection methods may be used as a supplemental technique for improving quality of delivery in video-phone applications. It also may be used as a separate technique for improving performance of RTSP/RTP-based streaming applications. One such architecture is shown in FIG. 17. In the example of FIG. 17, data is generated at a source node, such as a video camera 1756. The data is encoded at an encoder 1754 and uploaded to a Content Data Network (CDN) 1752. A streaming server 1750 takes the data from the CDN 1752 and streams it over the Internet 1728 to the gateway 1730 of an LTE/SAE network. As previously discussed, the gateway 1730 transmits the data to a base station, such as eNB 1720, which transmits the data over a wireless link 1715 to a receiving UE 1718. Like video conferencing or VoIP applications, RTSP streaming servers send video data over RTP. Furthermore, such data can be lost on the downlink between the remote base station 1730 and the receiving device 1718. As can be seen in FIG. 17, conventional signaling over RTCP involves multiple networks and segments, and may incur considerable delay. Employing transcoding and packet-loss detection and RPS or RSPS functionality (represented by line 1718) between the base station 1720 and the receiver 1718 should reduce propagation of errors caused by packet losses as described hereinabove.

In many cases, the transcoder in the base-station 1720 need not be even aware of the type of stream or application that it is dealing with. It may just parse packet headers to detect RTP and video content, and check if it was successfully delivered. If not successfully delivered, it may invoke transcoding to minimize error propagation without ever having, the need to know the type of the data of the application.

Unlike video conferencing or VoIP, streaming systems can tolerate delay and, in principle, use RTCP or proprietary protocols to implement application-level ARQ (and the accompanying retransmission of lost packets). To prevent such retransmissions, the transcoder additionally may generate and send delayed RTP packets with sequence numbers corresponding to lost packets. Such packets may contain no payload, or transparent (all skip mode) P frames.

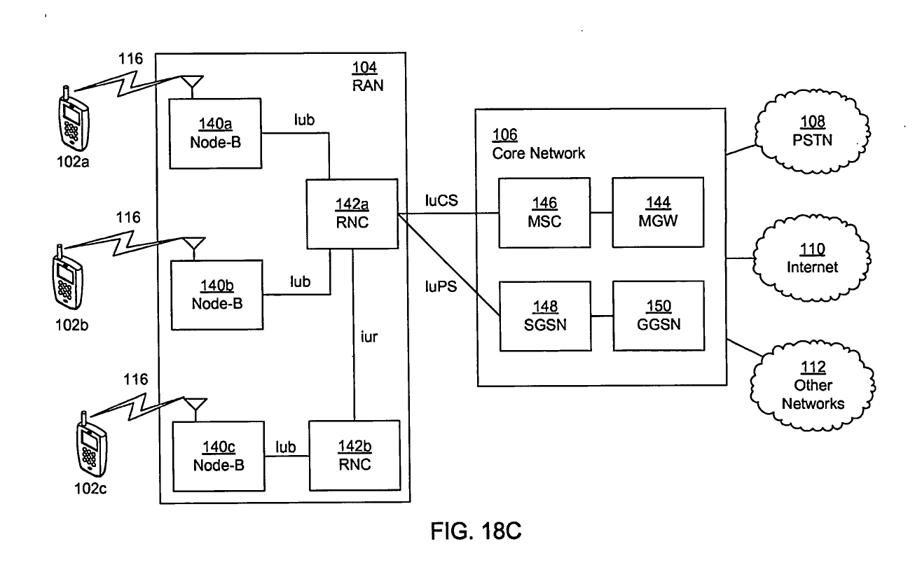

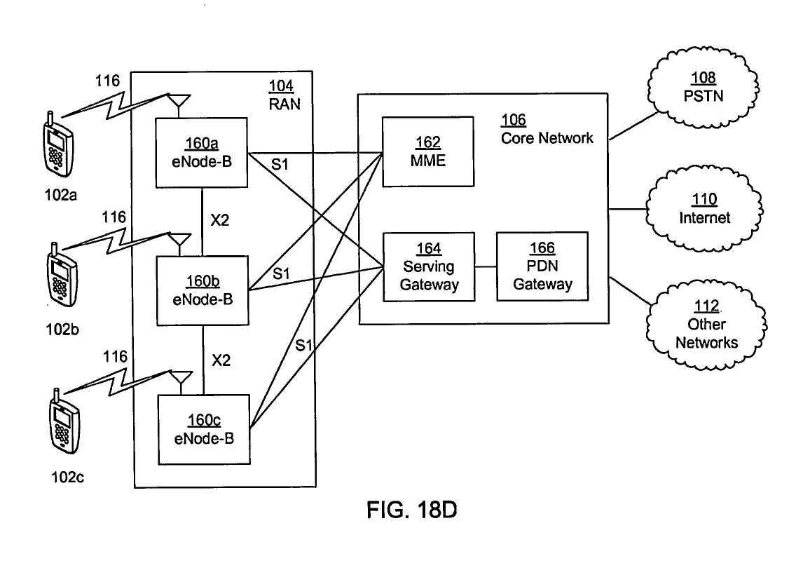

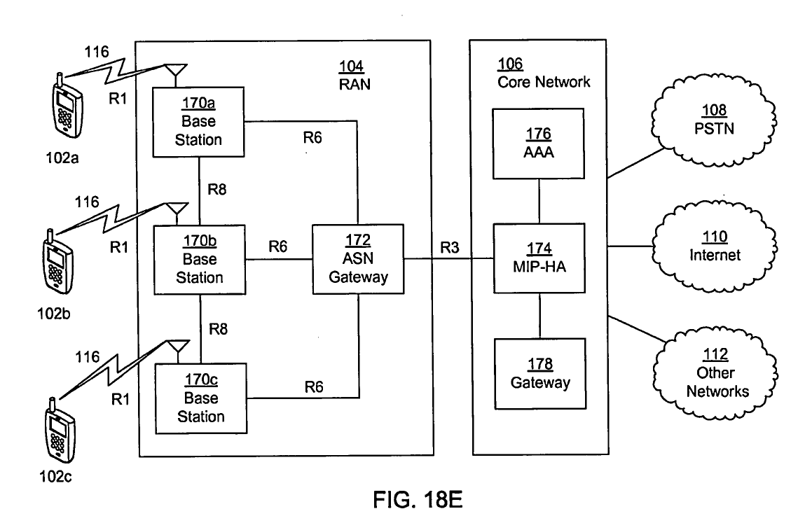

FIG. 18A is a diagram of an example communications system 100 in which one or more disclosed embodiments may be implemented. The communications system 100 may be a multiple access system that provides content, such as voice, data, video, messaging, broadcast. etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 18A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), as mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes. etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell, in another embodiment, the base station 114a may employ multiple-input multiple Output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established, using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA), WCDMA may include communication protocols such as High-Speed Packet Access (HSPA) arid/or Evolved HSPA (HSPA+), HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), interim Standard 856 (IS-856), Global System for Mobile communications (GSM), Enhanced Data rates for GSM Evolution (EDGE), GSM EDGE (GERAN), and the like.

The base station 114b in FIG. 18A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.1.5 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 18A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing, services, mobile location-based services, pre-paid calling, Internet connectivity, video distribution, etc., and/or perform high-level security functions, such as user authentication. Although not shown in FIG. 18A, it will be appreciated that the RAN 104 and/or the core network 106 may be in direct or indirect communication with other RAM that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 18A may be configured to communicate with the base station 114a, which may employ a cellular-based radio technology, and with the base station 114b, which may employ an IEEE 802 radio technology.

FIG. 18B is a system diagram of an example WTRU 102. As shown in FIG. 18B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 18B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 18B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering, the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e,g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 18C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 18C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 14bb. It will be appreciated that the RAN 104 may include any number of Node-Bs and RNCs while remaining consistent with an embodiment.

As shown in FIG. 18C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an fur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 18C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106. It will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also he connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 18D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also he in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 18D, the eNode-Bs 160a, 160b, 160c may communicate with one another over an X2 interface.

The core network 106 shown in FIG. 18D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving, gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the AIR Us 102a, 102b, 102c with access to the networks 112, which may include other wired or wireless networks that are owned and/or operated by other service providers.

FIG. 18E is a system diagram of the RAN 104 and the core network 106 according to another embodiment The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 18E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an RI reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 18E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator,

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 18E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Various acronyms, terms, and abbreviations have been used herein and may have included some of the following:
ACK Acknowledgment
AF Application Function
DPI Deep Packet Inspection
AM Acknowledged Mode
DPI Deep Packet Inspection
IP Internet Protocol
I-frame Intra frame
IDR frame Instantaneous Decode Refresh frame
LTE Long Term Evolution, a standard of cellular systems
MAC Media Access Control, a sub-layer on top of LTE NAY
MB Macroblock
MMCO Memory management control operation
NACK Negative Acknowledgment
NAL Network Abstraction Layer, format of video encoder output
PDCP Packet Data Control Protocol, a sub-layer on top of LTE RLC
PDU Protocol Data Unit
P-frame Prediction frame
P-GW PDN Gateway
PHY Physical layer of LTE
PCC Policy and Charging, Control in LTE
PCRF Policy Charging and Rule Function
PCEF Policy Charging Enforcement Function
PDN Packet Data Network (usually—external network connected to LTE over P-GW)
QCI QoS Class Identifier (9 values, defined in LTE)
QoS Quality of Service
RLC Radio Link Control, a sub-layer between LTE PDCP and MAC
RPS Reference Picture Refresh
RTCP Real-Time Control Protocol
RTP Real-time Transport Protocol, an application layer protocol
SAE System Architecture Evolution
SDF Service Data Flow
SDP Session Description Protocol
SDU Service Data Unit
SIP Session initiation Protocol
SN Sequence Number
TCP Transmission Control Protocol, a transport layer protocol
TM Transparent Mode
UDP User Datagram Protocol, a transport, layer protocol
UM Unacknowledged Mode

### Embodiments

In one embodiment, a method is implemented of transmitting video data over a network comprising: receiving wireless packet loss data at a wireless transmit receive unit (WTRU), determining video packet loss data from the wireless packet loss data; and providing the video packet loss data to a video encoder application running on the WTRU for use in encoding video data.

In accordance with this embodiment, the method may further comprise: the video encoder conducting an error propagation reduction process responsive to the video packet loss data.

One or more of the preceding embodiments may further comprise: wherein the error propagation reduction process includes generating an Instantaneous Decode Refresh frame.

One or more of the preceding embodiments may further comprise: wherein the error propagation reduction process includes generating an Intra Refresh frame.

One or more of the preceding embodiments may further comprise: wherein the error propagation reduction process includes generating encoded video using a reference picture selection method.

One or more of the preceding embodiments may further comprise: wherein the error propagation reduction process includes generating encoded video using reference set of pictures selection method.

One or more of the preceding embodiments may further comprise: wherein the error propagation reduction process includes generating encoded video using one or more reference pictures selected based on the packet loss indication data.

One or more of the preceding embodiments may further comprise: wherein the error propagation reduction process includes: generating an intra Refresh frame or an instantaneous Decode Refresh frame; generating encoded video using a P-predicted encoding mode; and selecting one of the Intra Refresh frame or an Instantaneous Decode Refresh frame, on the one hand, and the encoded video using a P-predicted encoding mode for transmission.

One or more of the preceding embodiments may further comprise: wherein the wireless packet loss data is provided by a base station to the wireless transmit receive unit (WTRU).

One or more of the preceding embodiments may further comprise: wherein the wireless packet loss data is generated at the Radio Link Control (RLC) protocol layer.

One or more of the preceding embodiments may further comprise: wherein the video packets are transported using Real Time Protocol (RTP).

One or more of the preceding embodiments may further comprise: wherein a wireless transport protocol is LIE.

One or more of the preceding embodiments may further comprise: wherein the RLC layer is operating in acknowledged mode.

One or more of the preceding embodiments may further comprise: wherein a number of ARQ retransmissions is set to zero in acknowledged mode.

One or more of the preceding embodiments may further comprise: wherein maxRetxThreshold is set to zero.

One or more of the preceding embodiments may further comprise: wherein the wireless packet loss data is obtained from RLC Status PDUs received from the base station.

One or more of the preceding embodiments may further comprise: wherein the wireless packet loss data is generated locally from a MAC transmitter.

One or more of the preceding embodiments may further comprise: wherein the video packet loss data is determined by identifying a PDCP sequence number in a header of as PDCP packet.

One or more of the preceding, embodiments may further comprise: wherein the RLC layer is operating in unacknowledged mode.

One or more of the preceding embodiments may further comprise: wherein the wireless packet loss data includes as NACK message.

One or more of the preceding embodiments may further comprise: wherein the NACK message is synchronous with uplink transmissions:

One or more of the preceding embodiments may further comprise: wherein the video packet loss data is generated from a mapping using a packet data convergence protocol (PDCP) sequence number.

One or more of the preceding embodiments may further comprise: wherein the determining the video packet loss data includes using a mapping from a real time protocol (RTP) sequence number in the RLC to a PDCP PDU sequence number.

One or more of the preceding embodiments may further comprise: wherein the mapping includes using a table lookup process.

One or more of the preceding embodiments may further comprise: wherein the determining the video packet loss data further includes mapping the PDCP PDU sequence number to an IP address, Port number, and RTP sequence number.

One or more of the preceding embodiments may further comprise: wherein the determining the video packet loss data further comprises performing deep packet inspection on the PDCP PDU.

One or more of the preceding embodiments may further comprise: wherein the mapping the PDCP PDU sequence number to an IP address, Port number, and RTP sequence number includes using a PDCP PDU sequence number lookup table.

One or more of the preceding embodiments may further comprise: mapping the RTP sequence number to a NAL packet identifier.

One or more of the preceding embodiments may further comprise: wherein the mapping the RTP sequence number to a NAL packet identifier comprises using a RTP sequence number to NAL packet identifier lookup table.

One or more of the preceding embodiments may further comprise: wherein the PDCP PDU sequence number lookup table is built using an RLC segmentor,

One or more of the preceding embodiments may further comprise: wherein the determining the video packet loss data includes mapping from an RLC packet to a PDCP sequence number to an RTP sequence number to a NAL.

One or more of the preceding embodiments may further comprise: wherein the video packet loss data is generated from the wireless packet loss data using a mapping from a radio link control (RLC) sequence number.

One or more of the preceding embodiments may further comprise: wherein the method is implemented in a network environment comprising at least a downlink wireless link and an uplink wireless link between the WTRU and a destination of the video data, the downlink wireless link disposed closer to the WTRU than the uplink wireless link, and wherein the wireless packet loss data pertains to the downlink wireless link, the method further comprising: implementing a higher QoS in the remote wireless link than in the local wireless link.

One or more of the preceding embodiments may further comprise: wherein the method is the network determining the QoS level for the remote wireless link.

One or more of the preceding embodiments may further comprise: wherein the method is implemented in a network environment comprising at least a downlink wireless link between the WTRU and an uplink base station and an uplink wireless link between a downlink base station and a destination receiver of the video data, the downlink wireless link disposed closer to the WTRU than the uplink wireless link, and wherein the wireless packet loss data pertains to the downlink wireless link, the method further comprising: the network determining whether to generate additional wireless packet loss data pertaining to the downlink wireless link.

One or more of the preceding embodiments may further comprise: wherein the determining, whether to generate additional wireless packet loss data pertaining to the remote wireless link includes determining the delay of data transmission between the WTRU and the downlink wireless link.

One or more of the preceding embodiments may further comprise: wherein the determining whether to generate additional wireless packet loss data pertaining to the downlink wireless link further comprises determining an application type of the video packet data using Deep Packet Inspection (DPI).

One or more of the preceding embodiments may further comprise: wherein the determining whether to generate additional wireless packet loss data pertaining to the downlink wireless link comprises: the WTRU sending a video packet over the network; performing DPI to detect the Service Data Flow (SDF) of the video packet data to determine an application type corresponding to the video packet data; the uplink base station sending a delay test packet to the downlink base station; the downlink base station sending an ACK message to the uplink base station in response to receipt of the delay Lest packet; the uplink base station calculating a delay between the uplink base station and the downlink base station; the uplink base station sending a delay report message to a network gateway; the network gateway deciding whether to generate additional wireless packet loss data pertaining to the remote wireless link based at least in part on the delay report message; and the gateway sending a message to the downlink base station indicating whether to generate additional wireless packet loss data pertaining to the remote wireless link.

One or more of the preceding embodiments may further comprise: wherein the delay test packet contains at least (1) the network address of the uplink base station, (2) the network address of the downlink eNB, and (3) a timestamp.

One or more of the preceding embodiments may further comprise: wherein the ACK message contains (1) the network address of the uplink base station, (2) the network address of the downlink base station; (3) a time stamp when the ACK is generated; and (4) a copy of the time stamp from the delay test packet.

One or more of the preceding embodiments may further comprise: a gateway in the network sending a request message to the uplink base station requesting the uplink base station to send the delay test packet to the downlink base station; and wherein the sending of the delay test packet by the uplink base station is performed responsive to receipt of the request message from the gateway.

One or more of the preceding embodiments may further comprise: wherein the delay test packet is an ICMP Ping message.

One or more of the preceding embodiments may further comprise: wherein the determining whether to generate additional wireless packet loss data pertaining to the downlink wireless link further comprises determining an application type of the video packet data using an Application Function process.

One or more of the preceding embodiments may further comprise: wherein the determining whether to generate additional wireless packet loss data pertaining to the downlink wireless link comprises: the WTRU sending an application packet through the network to a receiving node; an Application function (AF) in the network extracting application information from the application packet; the AF sending the extracted application information to a Policy Charging and Rule Function (PCRF) in the network; the PCRF determining an application type corresponding to the video data, determining QOS parameters for the video data as a function thereof and sending the QoS parameters to a gateway in the network; the uplink base station sending a delay test packet to the downlink base station; the downlink base station sending an ACK message to the uplink base station in response to receipt of the delay test packet; the uplink base station calculating a delay between the uplink base station and the downlink base station; the uplink base station sending a delay report message to a network gateway; the network gateway determining whether to generate additional wireless packet loss data pertaining to the remote wireless link based at least in part on the delay report and the QoS parameters received from the PCRF and the gateway sending a message to the downlink base station indicating whether to generate additional wireless packet loss data pertaining to the remote wireless link.

One or more of the preceding embodiments may further comprise: wherein the Application Function is P-CSCF (Proxy-Call Service Control Function).

One or more of the preceding embodiments may further comprise: wherein the application packet is a session Initiation Protocol (SIP) INVITE packet.

One or more of the preceding embodiments may further comprise: storing policies indicating QoS levels to be used for uplink traffic and for downlink traffic for at least one particular type of application; the network determining an application type of the video encoder; and the network setting a QoS level for the downlink wireless link and a QoS level for the uplink wireless link as a function of the policies and the application type of the video encoder.

One or more of the preceding embodiments may further comprise: wherein the downlink QoS is higher than the uplink QoS for each application.

One or more of the preceding embodiments may further comprise: wherein the at least one application is a video encoder.

One or more of the preceding embodiments may further comprise: wherein the method is implemented in a network environment comprising at least a downlink wireless link and an uplink wireless link between the WTRU and a destination receiver of the video data, the downlink wireless link disposed closer to the WTRU than the uplink wireless link, and wherein the wireless packet loss data pertains to the downlink wireless link, the method further comprising: transmitting the wireless packet data over the downlink wireless link; receiving wireless packet loss data from the destination node at the downlink base station; and determining video packet loss data from the wireless packet loss data received, at the downlink base station.

One or more of the preceding embodiments may further comprise providing the video packet loss data received at the downlink base station to a transcoder in the downlink base station for use in encoding the video data; and transcoding the video data at a downlink base station before passing through the downlink wireless link to the destination node;

One or more of the preceding embodiments may further comprise: wherein the transcoder performs the transcoding responsive to the wireless packet loss data.

One or more of the preceding embodiments may further comprise: wherein the transcoder conducts an error propagation reduction process on the video data responsive to the video packet loss data.

In another embodiment, a WTRU includes as processor configured to transmit video data over a network comprising, the processor further configured to: receive wireless packet loss data; determine video packet loss data from the wireless packet loss data; and provide the video packet loss data to a video encoder application running on the WTRU for use in encoding video data.

One or more of the preceding embodiments may further comprise: wherein the video encoder is configured to conduct an error propagation reduction process responsive to the video packet loss data.

One or more of the preceding embodiments may further comprise: wherein the error propagation reduction process includes at least one of: (a) generating an Instantaneous Decode Refresh frame: (h) generating an Intra Refresh frame; (c) generating encoded video using a reference picture selection method: (d) generating encoded video using a reference set of pictures selection method; and (e) generating encoded video using one or more reference pictures selected based on the packet loss indication data.

One or more of the preceding embodiments may further comprise: wherein the wireless packet loss data is received from a base station.

One or more of the preceding embodiments may further comprise: wherein the wireless packet loss data is in a Radio Link Control (RLC) protocol layer.

One or more of the preceding embodiments may further comprise: wherein the video packets are in Real Time Protocol (RTP).

One or more of the preceding embodiments may further comprise: wherein the RLC layer is operating in acknowledged mode.

One or more of the preceding embodiments may further comprise: wherein the wireless packet loss data is obtained from received RLC Status PDUs.

One or more of the preceding embodiments may further comprise: wherein the video packet loss data is determined by identifying a PDCP sequence number in a header of a PDCP packet.

One or more of the preceding embodiments may further comprise: wherein the RLC layer is operating in unacknowledged mode.

One or more of the preceding embodiments may further comprise: wherein the wireless packet loss data includes a NACK message.

One or more of the preceding embodiments may further comprise: wherein the NACK message is synchronous with uplink transmissions.

One or more of the preceding embodiments may further comprise: wherein the processor is further configured to generate the video packet loss data from a mapping using a packet data convergence protocol (PDCP) sequence number.

One or more of the preceding embodiments may further comprise: wherein the processor is further configured to generate the video packet loss data from using a mapping from a real time protocol (RTP) sequence number in the RLC to a PDCP PDU sequence number.

One or more of the preceding embodiments may further comprise: wherein the mapping includes using a table lookup process.

One or more of the preceding embodiments may further comprise: wherein the processor is configured to determine the video packet loss data by mapping the PDCP PDU sequence number to an IP address, Port number, and RTP sequence number.

One or more of the preceding embodiments may further comprise: wherein the processor is further configured to determine the video packet loss data by performing deep packet inspection on the PDCP PDU.

One or more of the preceding embodiments may further comprise: wherein the processor is further configured to map the PDCP PDU sequence number to an IP address, Port number, and RTP sequence number using a PDCP PDU sequence number lookup table.

One or more of the preceding embodiments may further comprise: wherein the processor is further configured to map the RTP sequence number to a NAL packet identifier.

One or more of the preceding embodiments may further comprise: wherein the processor is further configured to map the RTP sequence number to a NAL packet identifier.

One or more of the preceding embodiments may further comprise: wherein the processor is configured to determine the video packet loss data by mapping from an RLC packet to a PDCP sequence number to an RTP sequence number to a NAL.

In another embodiment, a base station in a network environment includes a processor configured to: receive input wireless packet data via the network; transmit the wireless packet data to a destination node over a wireless link: receive wireless packet loss data from the destination node; determine application layer packet loss data from the wireless packet loss data; and provide the application packet loss data to a transcoder in the base station fur use in transcoding application layer data in the wireless packet data.

One or more of the preceding embodiments may further comprise: wherein the application layer data is video data.

One or more of the preceding embodiments may further comprise: wherein the transcoder is configured to transcode the wireless packet data to application layer data and back before transmitting the passing through the downlink wireless link to the destination node.

One or more of the preceding embodiments may further comprise: wherein the processor is further configured to cause the transcoder to perform the transcoding responsive to the wireless packet loss data.

One or more of the preceding embodiments may further comprise: wherein the processor is further configured to cause the transcoder to conduct an error propagation reduction process on the application layer data responsive to the wireless packet loss data.

In another embodiment, an apparatus comprising a computer readable storage medium has instructions thereon that when executed by a processor cause the processor to provide wireless packet loss data to a video encoder.

In another embodiment, an apparatus comprising a computer readable storage medium has instructions thereon that when executed by a processor cause the processor to encode video data based on an indication of lost video packets.

### Conclusion

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus, and system described above are possible without departing from the scope of the invention. In view of the wide variety of embodiments that can be applied, it should be understood that the illustrated embodiments are exemplary only, and should not be taken as limiting the scope of the following claims.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained, on a computer readable medium including magnetic disks, optical disks, and any other volatile (e.g., Random Access Memory (“RAM”)) or non-volatile Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

No element, act, or instruction used in the description of the present: application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶6, and any claim without, the word “means” is not so intended.

What is claimed:

1. A method of transmitting video data over a network comprising:
receiving wireless packet loss data at a wireless transmit receive unit (WTRU), the wireless packet loss data including the identity of lost wireless packets;
determining video packet loss data from the wireless packet loss data, the video packet loss data including the identity of lost video packets; and
using the video packet loss data in encoding video data.

2. The method of claim 1 further comprising:
conducting an error propagation reduction process responsive to the video packet loss data.

3. The method of claim 2 wherein the error propagation reduction process includes generating an Instantaneous Decode Refresh frame.

4. The method of claim 2 wherein the error propagation reduction process includes generating an Intra Refresh frame.

5. The method of claim 2 wherein the error propagation reduction process includes generating encoded video using a reference picture selection method.

6. The method of claim 2 wherein the error propagation reduction process includes generating encoded video using a reference set of pictures selection method.

7. The method of claim 2 wherein the error propagation reduction process includes generating encoded video using one or more reference pictures selected based on the video packet loss data.

8. The method of claim 2 wherein the error propagation reduction process includes:
generating an Intra Refresh frame or an Instantaneous Decode Refresh frame;
generating an encoded video frame using a P-predicted encoding mode; and
selecting one of (1) the Intra Refresh frame or an Instantaneous Decode Refresh frame and (2) the encoded video frame using a P-predicted encoding mode for transmission.

9-19. (canceled)

20. The method of claim 1 wherein the wireless packet loss data includes a NACK message.

21-53. (canceled)

54. A WTRU including a processor configured to transmit video data over a network, the processor configured to:
receive wireless packet loss data identifying wireless packets lost in transmission;
determine video packet loss data from the wireless packet loss data, the video packet loss data including the identity of lost video packets; and
provide the video packet loss data to a video encoder application running on the WTRU for use in encoding video data.

55. The WTRU of claim 54 wherein the video encoder is configured to conduct an error propagation reduction process responsive to the video packet loss data.

56. The WTRU of claim 55 wherein the error propagation reduction process includes at least one of: (a) generating an Instantaneous Decode Refresh frame; (b) generating an Intra Refresh frame; (c) generating encoded video using a reference picture selection method; and (d) generating encoded video using a reference set of pictures selection method.

57-63. (canceled)

64. The WTRU of claim 54 wherein the wireless packet loss data includes a NACK message.

65. The WTRU of claim 64 wherein the NACK message is synchronous with uplink transmissions.

66-81. (canceled)
